(19) United States
(12) Patent Application Publication
(10) Pub. No.: US 2026/0275000 A1
(43) Pub. Date: Sep. 17, 2026

(54) PROCESS FOR THE PREPARATION OF A THERMOPLASTIC MOLDING COMPOSITIONS WITH GOOD COLOR STABILITY

(71) Applicant: INEOS STYROLUTION GROUP GMBH, Frankfurt am Main (DE)

(72) Inventors: Gisbert MICHELS, Leverkusen (DE); Norbert NIESSNER, Friedelsheim (DE); Tristan KOLB, Bayreuth (DE)

(21) Appl. No.: 19/166,986

(22) PCT Filed: Mar. 19, 2024
(86) PCT No.: PCT/EP2024/057235

§ 371 Date: Sep. 19, 2025

(30) Foreign Application Priority Data
Mar. 21, 2023 (EP) 23163174.8

(51) Int. Cl. C08C 1/00; C08K 5/05; C08K 5/37

(52) U.S. Cl. CPC C08C 1/00; C08K 5/05; C08K 5/37

(57) ABSTRACT

A process for the preparation of a thermoplastic molding composition based on ABS copolymers is described in which two or more phenolic stabilizers A selected from A2: octadecyl 3-(3,5-di-tert-butyl-4-hydroxyphenyl)propionate); A3: benzenepropanoic acid, 3,5-bis(1,1-dimethylethyl)-4-hydroxy-1,1′-(thiodi-2,1-ethanediyl) ester; and A4: 2,4,6-tris(3′,5′-di-tert-butyl-4′-hydroxybenzyl)mesitylene, and thio-co-stabilizers B are used. ABS molding compositions obtained by said process have a good color stability.

The present invention relates to a process for the preparation of a thermoplastic molding composition based on acrylonitrile butadiene styrene copolymers (ABS) with good color stability and an ABS molding composition obtained by said process.

Polymer dispersions, in particular so called emulsion rubbers or polymer latexes, which are obtained by emulsion polymerization are used for a very wide variety of applications, e.g. emulsion paints, paper coatings, leather finishing, textile finishing, raw materials for adhesives. It is well known to incorporate isolated solid emulsion graft rubber copolymers into thermoplastic molding compositions as impact modifiers.

Furthermore, it is known in the state of the art to incorporate emulsion graft rubber copolymers, e.g. grafted polybutadiene rubbers, into styrene acrylonitrile copolymers (SAN) or α-methylstyrene acrylonitrile copolymer (AMSAN) to produce ABS polymers or into blends of SAN and AMSAN or into polymer blends of SAN or AMSAN with further polymers like polycarbonates (PC), polyestercarbonates (PEC) or polyamides (PA) in order to improve the impact strength of the thermoplastic composition. Such acrylonitrile butadiene styrene copolymers (ABS) and acrylonitrile butadiene α-methyl-styrene copolymers (in general also called ABS) and blends with ABS polymer have been used for many years for the production of molding for several application, e.g. for the automotive sector. Generally, such ABS moldings modified to impact strength can be produced by free radical emulsion graft polymerization of styrene and acrylonitrile in the presence of a polybutadiene latex or by mixing of a polybutadiene latex grafted with styrene and acrylonitrile by free radical emulsion polymerization, which is prepared and isolated separately, and the thermoplastic SAN matrix. The term emulsion polymerization and free radical emulsion polymerization have the same meaning in this document.

Beside the particular advantageous mechanical properties of ABS compositions, such as high impact strength and notched impact strength, high elasticity, and good processability (melt flow index), the resistance against the influence of heat and UV deposition are of particular importance. For stabilization of ABS polymer compositions or other polymers produced by graft emulsion polymerization on polybutadiene latexes, it is often necessary to add stabilizers, in particular in form of dispersions, to prevent the polymers against oxidative decomposition, e.g. promoted by light, UV, heat stress. For example, thermoplastic ABS compositions and stabilized ABS compositions and their preparation are described in WO 2001/62848, WO 2008/020012, and WO 2009/071537.

EP-A 038876 discloses polymer compositions (e.g. ABS-terpolymers, SAN-copolymers) comprising stabilizer compositions comprising phenolic antioxidants in combination with 2,6-di-tert. butyl phenyl pentaerythritol spiro bis-phosphites. In a long list of exemplified phenolic antioxidants i.a. thiodiglycolbis-(3, 5-di-t-butyl-4-hydroxyphenyl propionate) and stearyl-3-(3,5-di-t-butyl-4-hydroxyphenyl) propionate are mentioned. Examples 24, 25 and 31 to 35 show PP or HDPE compositions comprising 0.1 or 0.3 pbw of one of said antioxidants.

WO 2015/078877 disclose stabilizing compositions used for polymer compositions, preferably polyethylene, comprising a first stabilizing component comprising at least one fully hindered phenolic antioxidant (a); a second stabilizing component comprising at least one partially hindered phenolic antioxidant (b); and a third stabilizing component comprising at least one sulphur-containing antioxidant (c). In a list of 13 suitable antioxidants (a) i.a. octadecyl 3-(3′,5′-di-t-butyl-4′-hydroxyphenyl) propionate (ANOX® PP18—CAS 2082-79-3), 2,2′thiodiethylene bis[3(3,5-di-t-butyl-4-hydroxyphenyl)propionate] (ANOX® 70—CAS 41484-35-9) and 1,3,5-trimethyl-2,4,6-tris(3,5-di-t-butyl-4-hydroxybenzyl)benzene (ANOX® 330—CAS 1709-70-2) are mentioned. Exemplified are mixtures of octadecyl 3-(3′,5′-di-t-butyl-4′-hydroxyphenyl) propionate (a), dilauryl-3,3′-thiodipropionate (c) and triethyleneglycol-bis-[3-(3-t-butyl-4-hydroxy-5-methylphenyl)-propionate], or, a mixture of 2,2-thiodiethylene bis[3-(3,5-d i-t-butyl-4-hydroxy-phenyl)propionate] (a) and distearyl thiodipropionate (c). In none of the examples two or more antioxidants (a) are used. The stabilizing composition is used for polyolefin based polymeric materials, i.e. LDPE. ABS compounds are not mentioned.

CN 102181123 A discloses flame-retardant ABS (acrylonitrile-butadiene-styrene) materials which comprise 0.3 to 0.6 pbw of at least one of antioxidant 1076, antioxidant 1010, antioxidant 300, antioxidant 245, antioxidant 1035, antioxidant 1222, antioxidant 168, BHT. In all examples a combination of antioxidant 1010 and antioxidant 168 or antioxidant 245 has been used.

CN 101824202 A and CN 102040798 A disclose a composite processing stabilizer for ABS and HIPS resins composed of a bisphenol monoacrylic acid antioxidant, a phenolic antioxidant and an auxiliary antioxidant. The phenolic antioxidant is preferably antioxidant 1076 (octadecyl-3,5-bis(1,1-dimethylethyl)-4-hydroxyphenylpropionate), antioxidant 1010, antioxidant WSL (Wingstay L), antioxidant 300, antioxidant 245, antioxidant 1035 (2,2′-thioethylene glycol bis [β-(3,5-di-tert-butyl-4-hydroxyphenyl) propionate]), and antioxidant 1222. Preferably, the auxiliary antioxidant is TNPP, antioxidant 168, P-EPQ, antioxidant 626, DLTP, DSTP. In each exemplified ABS composition only one phenolic antioxidant has been used.

CN102643508 A describes a flame-retardant ABS material comprising 0.5-1.5 parts antioxidant. A suitable antioxidant is antioxidant 1010, antioxidant 1330, antioxidant 1076, antioxidant 1034, antioxidant 168, antioxidant 618, antioxidant 300, antioxidant DSTP and antioxidant DMTDP. No specific mixture of said antioxidants has been mentioned or used in the examples.

CN 109825025 A discloses a heat and light resistant ABS composition comprising 0.15 to 1 wt.-% antioxidant. The antioxidant is one or a combination of components selected from a long list including phenolic antioxidants (i.a. β-(octadecanol 3,5-di-tert-butyl-4-hydroxyphenyl)propionate, 1,3,5-trimethyl-2,4,6-tris(3,5-di-tert-butyl-4-hydroxybenzyl)benzene and 2,2′-thiodiethylbis[3-(3,5-di-tert-butyl-4-hydroxyphenyl)propionate]) and phosphite antioxidants. In the examples none of the hereinbefore mentioned phenolic antioxidants has been used.

JP 02103253 A relates to vinylaromatic diene block copolymers stabilized with 0.5 to 5 phr at least one specific phenolic compound and to their blends with thermoplastic polymers or rubbers. In the examples a block copolymer was subjected to extrusion granulation in presence of a phenolic antioxidant AO1 to AO13 (e.g. AO-6: n-octadecyl-3-(3′,5′-di-tert-butyl-4′ hydroxy-phenyl) propionate, or AO-8: 1,3,5-trimethyl-2,4,6-(3,5-di-tert-butyl-4-hydroxy-benzyl) benzene). A block copolymer stabilized with a mixture comprising both antioxidants AO6 and AO8 is not disclosed.

WO 2018/202791 relates to stabilizing compositions for stabilizing polymers such as polyolefins. The stabilizing composition comprises at least one antioxidant comprising one or more of: i. a phenolic antioxidant; ii. a phosphite antioxidant; iii. a sulphur-containing antioxidant; and iv. an aminic antioxidant. In a longer list as suitable (hindered) phenolic antioxidants i.a. 2,2′-thiodiethylene bis[3(3,5-di-t-butyl-4-hydroxyphenyl)propionate] (ANOX™ 70—CAS 41484-35-9); octadecyl 3-(3′,5′-di-t-butyl-4′-hydroxyphenyl) propionate (ANOX™ PP18—CAS 2082-79-3); and 1,3,5-trimethyl-2,4,6-tris(3,5-di-t-butyl-4-hydroxybenzyl)benzene (ANOX™ 330—CAS 1709-70-2) are proposed. The polymer material is preferably based on polyolefin, i.e. PE and/or PP, or a styrenic block copolymer. All examples show PP polymers stabilized with a composition comprising only one phenolic stabilizer.

WO 1995/02639 discloses a process for stabilizing recycled styrene-containing plastic materials (e.g foamed PS, ABS waste) wherein 0.01 to 10 wt % of a mixture of a) at least one sterically hindered phenol and b) an inorganic compound (e.g. metal oxide). One of the most preferred components a) is the octadecyl ester of β-(3,5-di-tert-butyl-4-hydroxyphenyl)propionic acid (AO-2).

In a long list of representative examples of such sterically hindered phenols i.a. 1,3,5-tris(3,5-ditert-butyl-4-hydroxybenzyl)-2,4,6-trimethylbenzene is mentioned. In a second list as one of further preferred compounds (thiodi-2,1-ethanediyl-3,5-bis(1,1-dimethyl)-4-hydroxyphenylpropanoate) is disclosed. In all exemplified compositions with foamed PS only one phenolic stabilizer a) (e.g. AO-2) has been used. In none of the examples a thio co-stabilizer B is used.

Emelyanova et al. (Zhurnal Prikladnoi Khimii, (1979), 52(9), 2055-60) tested 15 stabilizers including phenols (i.a. benzenepropanoic acid 3,5-bis(1,1-dimethylethyl)-4-hydroxy-1,1′-(thiodi-2,1-ethanediyl) ester; 2,4,6-Tris(3′,5′-di-tert-butyl-4′-hydroxybenzyl)mesitylene; octadecyl 3-(3,5-di-tert-butyl-4-hydroxyphenyl)propionate (preferred), thiophenols, etc. in order to increase the thermal stability of an ABS copolymer. Mixtures of said stabilizers have not been used in this study.

Often the stabilizers are used as dispersions. Usually such stabilizer dispersions comprise phenolic antioxidants in order to stabilize the polymer with respect to oxidative phenomena. Often the phenolic antioxidants are used in combination with co-stabilizers, such as organic sulfur compounds (organosulfur compounds) or organic phosphor compounds (organophosphorus compounds). It is also common to use further additives, such as light stabilizers, antistatic agents and further usual additives in the production of the stabilizer dispersion and/or of the thermoplastic compositions. In particular, silicon oils, such as polydimethylsiloxane, are used as additive in ABS compositions in particular to improve the resistance against chemical compounds and to improve the impact strength.

Normally, dispersions are systems consisting of at least one inner phase (also called disperse phase), which is homogenously and finely distributed in the so-called outer or continuous phase. Normally, dispersions are prepared by introducing the required dispersion energy into the system, e.g. by mechanical energy. As a rule, in common dispersions, so called macro dispersions, the mean size of the disperse phase particles is in the range of 100 nm and 1 mm. Macro-emulsions are thermodynamically unstable and often separate within a certain time depending on conditions, such as stabilization, temperature, and pH value. Several methods and devices for the preparation of dispersions are known by a skilled person. Surface-active substances, so-called surfactants or dispersing agents, which facilitate the formation of the dispersed phase particles (e.g. droplets or solid particles) and counteract phase separation, are normally important components of the dispersion.

Aqueous stabilizer dispersions for stabilizing ABS compositions against heat and UV decomposition, which comprise a phenolic stabilizer and a co-stabilizer, such as organic sulfur compounds (organosulfur compounds) or organic phosphor compounds, often have to be prepared using expensive multistage processes in order to ensure homogeneous distribution of the components.

DE 199 46 519 A1 and WO 2001/23498 disclose a continuous process for the preparation of an aqueous stabilizer dispersion S for the stabilization of polymer dispersions, i.e emulsion graft copolymers. Said stabilizer dispersion S preferably comprises a phenolic antioxidant C, a thio co-stabilizer D and a surfactant A. Exemplified are stabilizer dispersions S wherein the phenolic antioxidant C is a mixture of C1: octadecyl 3-(3,5-di-tert-butyl-4-hydroxyphenyl)propionate (CAS Number: 2082-79-3), C2: a butylated reaction product of p-cresol and dicyclopentadiene (Wingstay L), C3: 1,1,3-tris-(2′-methyl-4′-hydroxi-5′-tert.-butylphenyl)butane (Topanol CA), and C4: 4,4′-thiobis-(3-methyl-6-tert.butylphenol).

WO 2017/211783 discloses a process for the preparation of homogenous aqueous stabilizer dispersions S, which are suitable to produce stabilized compositions based on acrylonitrile butadiene styrene copolymers (ABS). The stabilizer dispersion S comprises at least one phenolic stabilizer A, at least one thio co-stabilizer B (i.e. dilauryl thiodipropionate (DLTP)), at least one surfactant C (i.e. K-stearate or oleic acid), and at least one silicon oil D. Preferably, the phenolic stabilizer A is a butylated reaction product of p-cresol and dicyclopentadiene according to formula (Ia) with n=1-3 (CAS Number: 68610-51-5, i.e. Wingstay L)

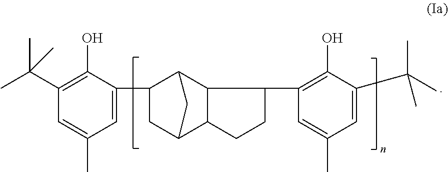

Beside said phenolic stabilizer A of formula (Ia) other conventional antioxidants may be comprised in the stabilizer dispersion S. In a list of 15 preferred phenolic stabilizers A said stabilizer A of formula (Ia) and i.a. 1,3,5-trimethyl-2,4,6-tris(3,5-di-tert-butyl-4-hydroxybenzyl)benzene (CAS 1709-70-2) or octadecyl 3-(3,5-bis(1,1-dimethylethyl)-4-hydroxyphenyl)propionate (CAS 2082-79-3) are mentioned. In all exemplified stabilizer dispersions only one phenolic stabilizer A, namely said of formula (Ia), has been used.

In many of the afore-mentioned prior art ABS molding compositions as phenolic stabilizer Wingstay L has been used which, due to regulatory aspects, may no longer be used in ABS polymers in the future.

Thus, there is a need to provide improved acrylonitrile butadiene styrene copolymer (ABS) molding compositions and a process for their preparation which have a good base color, good color stability during processing (injection molding), and a good long time stability during the life cycle time of an injection molded article, which also fulfill (future) regulatory requirements.

Object of the invention is to provide a process for the preparation of acrylonitrile butadiene styrene copolymer (ABS) molding compositions which have a good or—compared to the afore-mentioned prior art compositions comprising a phenolic stabilizer A of formula (Ia)—improved base color, a good or improved color stability during processing (injection molding), and a good or improved long time stability during the life cycle time of an injection molded article. Moreover, the ABS molding composition obtained by said process shall only comprise phenolic stabilizers (antioxidants) which fulfill (future) regulatory requirements.

One aspect of the invention is a process for the preparation of a thermoplastic molding composition (based on ABS) comprising:
0 to 94.996% by weight, preferably 5 to 80% by weight, based on the total thermoplastic molding composition, of a rubber free thermoplastic copolymer CA comprising at least 50% by weight of one or more vinyl aromatic monomer(s) CA11, preferably selected from styrene and α-methyl styrene, and mixtures of monomer CA11 with at least one other co-monomer CA12, in particular at least one vinyl cyanide monomer;
5 to 99.996% by weight, preferably 15 to 60% by weight, based on the total thermoplastic molding composition, of a graft copolymer CB, comprising
   5 to 95% by weight, based on the graft copolymer CB, of at least one graft base CB1, which is obtained by emulsion polymerization of
      CB11: 50 to 100% by weight, based on the graft base CB1, of at least one conjugated diene B11, in particular 1,3-butadiene,
      CB12: 0 to 50% by weight, based on the graft base CB1, of at least one further monomer CB12 selected from styrene, α-methyl styrene, acrylonitrile, methacrylonitrile, and methyl methacrylate, in particular styrene; and
   5 to 95% by weight, based on the graft copolymer CB, of at least one graft shell CB2, which is obtained by emulsion polymerization in the presence of the at least one graft base CB1 of:
      CB21: 50 to 95% by weight, based on the graft shell CB2, of a monomer CB21 selected from styrene, α-methyl styrene, and mixtures of styrene and at least one more monomer selected from α-methyl styrene, p-methyl styrene and (meth)acrylic acid C₁-C₈-alkyl esters, in particular styrene;
      CB22: 5 to 50% by weight, based on the graft shell CB2, of a monomer B22, selected from acrylonitrile and mixtures of acrylonitrile and at least one more monomer selected from methacrylonitrile, maleic anhydride, phthalic anhydride, N-phenyl maleimide, N-cyclohexyl maleimide, in particular acrylonitrile,
   wherein the sum of CB11+CB12 is 100% by weight; the sum of CB21+CB22 is 100% by weight, and the sum of graft base CB1 and graft shell CB2 is 100% by weight;
0.002 to 5% by weight, preferably 0.01 to 3% by weight, more preferably 0.1 to 1% by weight, based on the total thermoplastic molding composition, of two or more phenolic stabilizers A selected from:
   A2: octadecyl 3-(3,5-di-tert-butyl-4-hydroxyphenyl)propionate (CAS Number: 2082-79-3);
   A3: benzenepropanoic acid, 3,5-bis(1,1-dimethylethyl)-4-hydroxy-, 1,1′-(thiodi-2,1-ethanediyl) ester (CAS Number: 41484-35-9); and
      A4: 2,4,6-tris(3′,5′-di-tert-butyl-4′-hydroxybenzyl)mesitylene (CAS Number: 1709-70-2);
      wherein the phenolic stabilizers A are preferably a combination of phenolic stabilizers A2 and A3, or A2 and A4, or A2, A3 and A4, in a weight ratio A2:A3, or A2:A4, or A2:(A3+A4) of 90 to 55:10 to 45, preferably 85 to 60:15 to 40, more preferably 80 to 65:20 to 35;
0.002 to 5% by weight, preferably 0.01 to 3% by weight, more preferably 0.1 to 1% by weight, based on the total thermoplastic molding composition, of at least one thio co-stabilizer B;
optionally up to 2% by weight, preferably 0.001 to 1% by weight, more preferably 0.01 to 0.2% by weight, based on the total thermoplastic molding composition, of at least one silicon oil component D;
0 to 30% by weight, preferably 0 to 10% by weight, more preferably 0.01 to 1% by weight, based on the total thermoplastic molding composition, of at least one further component K selected from:
additives and/or auxiliaries different from A, B and D, provided that phenolic stabilizers A1—a butylated reaction product of p-cresol and dicyclopentadiene (CAS Number: 68610-51-5)—are excluded, residues of the at least one surfactant C used for production of the stabilizer dispersion S, and/or at least one further polymer selected from polycarbonates PC, polyestercarbonates PEC and polyamides PA;
which process encompasses the following steps:
x) adding a stabilizer dispersion S to the graft copolymer CB after its emulsion polymerization which stabilizer dispersion S is obtained by a process comprising the following steps, the order of step ii) to v) can be changed:
   i) providing an aqueous composition, preferred water;
   ii) adding at least one surfactant C to the aqueous composition;
   iii) optionally adding at least one thio co-stabilizer B to the aqueous composition, wherein the temperature of the aqueous composition is higher than or equal to the melting point of the at least one thio co-stabilizer B;
   iv) adding at least one, often two or more, of the phenolic stabilizers A, preferably a combination of phenolic stabilizers A2 and A3, or, a combination of phenolic stabilizers A2 and A4, or further preferred phenolic stabilizer A2 alone, to the aqueous composition, wherein the temperature of the aqueous composition is higher than or equal to the melting point of the optionally at least one thio co-stabilizer B, at least 40° C.;
   v) optionally adding at least one silicon oil component D to the aqueous composition;
   vi) homogenization of the aqueous composition obtained in steps ii) to v) for producing a stabilizer dispersion S;
xi) precipitation of the graft copolymer CB, obtained in step x) (including the stabilizer dispersion S), by adding a precipitation solution comprising at least one salt;
xii) mechanical dewatering, optional washing and/or optional drying of the precipitated graft copolymer CB obtained in step xi);
prexiii) optionally providing a thermoplastic copolymer CA;
prexiii′) optionally providing a stabilized pre-mixture of a thermoplastic copolymer CA with at least one, often two or more, of the phenolic stabilizers A, preferably a combination of phenolic stabilizers A2 and A3, or a combination of phenolic stabilizers A2 and A4, or further preferred phenolic stabilizer A3 or A4 alone, and the at least one thio co-stabilizer B, and optionally the at least one silicon oil component D;
xiii) optionally mixing the graft copolymer CB obtained in step xii) with the thermoplastic copolymer CA, and optionally with further components K, or
xiii′) optionally mixing the graft copolymer CB obtained in step xii) with the stabilized pre-mixture obtained in step prexiii′), and optionally with further components K; and
xiv) mixing the composition obtained in step xii) or xiii) with at least one, often two or more, of the phenolic stabilizer A, preferably a combination of phenolic stabilizers A2 and A3, or a combination of phenolic stabilizers A2 and A4, or further preferred phenolic stabilizer A3 or A4 alone, and the at least one thio co-stabilizer B, and optionally the at least one silicon oil component D.

In a preferred embodiment the amounts of the components CA, CB, A, B, D and optional K are summed up to 100% by weight. In particular, the amount of the graft copolymer CB can be adapted so that the sum of the compounds results in 100% by weight.

The optional at least one thermoplastic copolymer CA, the at least one graft copolymer CB, the two or more phenolic stabilizers A, the at least one thio co-stabilizer B, the optional at least one silicon oil component D, the optional at least one further component K, the stabilizer dispersion S, and suitable processes for the production of the stabilizer dispersion S, as well as preferred embodiments of the process according to the invention are described in detail hereinafter.

### Graft Copolymer CB

Preferably, graft copolymer CB comprises:
5 to 95% by weight, preferably 40 to 85% by weight, based on the graft copolymer CB, of at least one graft base CB1, which is obtained by emulsion polymerization of:
   CB11: 50 to 100% by weight, preferably 79 to 100% by weight, based on the graft base CB1, of at least one conjugated diene CB11, in particular 1,3-butadiene,
   CB12: 0 to 50% by weight, preferably 0 to 21% by weight, based on the graft base CB1, of at least one further monomer CB12 selected from styrene and α-methyl styrene, in particular styrene; and
5 to 95% by weight, preferably 15 to 60% by weight, based on the graft copolymer CB, of at least one graft shell CB2, which is obtained by emulsion polymerization in the presence of the at least one graft base CB1 of:
   CB21: 50 to 95% by weight, preferably 70 to 90% by weight, based on the graft shell CB2, of a monomer CB21, selected from styrene, α-methyl styrene, and mixtures of styrene and at least one more monomer selected from α-methyl styrene and methyl(meth)acrylate, preferably styrene and/or α-methyl styrene, more preferably styrene;
   CB22: 5 to 50% by weight, preferably 10 to 30% by weight, based on the graft shell CB2, of a monomer B22, selected from acrylonitrile and mixtures of acrylonitrile and at least one more monomer selected from methacrylonitrile, maleic anhydride, N-phenyl maleimide, in particular acrylonitrile.

The average particle diameter of graft copolymer CB may vary from 50 nm to 10,000 nm, preferred 80 nm to 3,000 nm, more preferred from 100 nm to 2,000 nm.

The particle size distribution of the graft copolymer CB can be mono-, bi-, or poly-modal. According to one particularly preferred embodiment of the invention, the particle size distribution is bimodal.

Suitable as the at least one conjugated diene CB11 are 1,3-butadiene and isoprene, preferably 1,3-butadiene.

Preferably, monomer CB11 is 1,3-butadiene, and monomer CB12 is preferably styrene and/or α-methyl styrene, in particular styrene.

Preferably, monomer CB21 is styrene and/or α-methyl styrene, in particular styrene, and monomer CB22 is preferably acrylonitrile.

In a preferred embodiment the monomer CB11 is 1,3-butadiene.

The graft base CB1 can by way of example be obtained via reaction of from 0 to 10% by weight of styrene and from 90 to 100% by weight of butadiene.

In a preferred embodiment the graft copolymer CB is an ABS graft copolymer composed of a graft base CB1, obtained by emulsion polymerization of monomer CB11 which is 1,3-butadiene and monomer CB12 which is styrene, and a graft shell CB2, which is obtained by emulsion polymerization of monomer CB21, selected from styrene, α-methyl styrene, and mixtures thereof, and the monomer B22, which is acrylonitrile, in the presence of the graft base CB1.

The graft copolymer CB often has a complex structure and is in essence composed of a graft base CB1 and a graft shell CB2. The graft copolymer CB is polymerized by emulsion polymerization, wherein firstly the graft base CB1 is obtained via emulsion polymerization of the monomers CB11 and optionally CB12 and afterwards the graft shell CB2 is obtained via emulsion polymerization of the monomers CB21 and CB22 in the presence of the graft base CB1. Preferably, the graft copolymer CB is polymerized by aqueous free-radical emulsion polymerization. The reaction is typically initiated via water-soluble or oil-soluble free-radical polymerization initiators, e.g. inorganic or organic peroxides, such as peroxodisulfate or benzoyl peroxide, or with the aid of redox initiator systems. The documents WO 2002/10222, DE-A 28 26 925 and EP-A 022 200 describe suitable polymerization processes.

Graft copolymers CB which can be preferably used in the inventive process are for example graft latexes described in EP-B 0 845 496, WO 2009/071537 and WO 2014/170407.

Preferably, graft bases CB1, having a multi- or bimodal, more preferably a bimodal, particle size distribution, may be obtained by agglomerating the graft base after its emulsion polymerization, using an agglomerating copolymer, in particular an agglomerating latex, as described in WO 2008/020012, wherein the graft shell CB2 is obtained by emulsion polymerization of the monomers CB21 and CB22 in the presence of the agglomerated graft base.

In a preferred embodiment the graft copolymer CB comprises
CB1: 40 to 85% by weight, based on the graft copolymer CB, of at least one graft base CB1, which is obtained by emulsion polymerization of:
   CB11: 79 to 100% by weight, based on the graft base CB1, of at least one conjugated diene CB11, preferably 1,3-butadiene;
   CB12: 0 to 21% by weight, based on the graft base CB1, at least one further monomer CB12 selected from styrene and α-methyl styrene, in particular styrene;
   wherein the sum of CB11+CB12 is 100% by weight;
   and agglomerating the obtained graft base CB1 by adding
      0.01 to 5 parts by weight, based on 100 parts by weight of the graft base CB1, in each case based on the solids content, of an agglomerating copolymer CP composed of:
      CP1: 80 to 99.9 wt % of one or more hydrophobic C1 to C12 alkyl acrylates or C₁ to C₁₂ alkyl methacrylates and
      CP2: 0.1 to 20 wt % of one or more hydrophilic comonomers selected from the group consisting of methacrylamide, acrylamide, methylacrylamide, ethylacrylamide and n-butylacrylamide,
      where CP1 and CP2 sum to 100 wt %;
and
   CB2: 15 to 60% by weight, based on the graft copolymer CB, of at least one graft shell CB2, which is obtained by emulsion polymerization in the presence of the agglomerated at least one graft base CB1 of:
      CB21: 70 to 90% by weight, based on the graft shell CB2, of a monomer CB21, selected from styrene, α-methyl styrene, and mixtures of styrene and at least one more monomer selected from α-methyl styrene and methyl(meth)acrylate, in particular styrene and/or α-methyl styrene;
      CB22: 10 to 30% by weight, based on the graft shell CB2, of a monomer CB22, selected from acrylonitrile and mixtures of acrylonitrile and at least one more monomer selected from acrylonitrile and mixtures of acrylonitrile and at least one more monomer selected from methacrylonitrile, maleic anhydride, N-phenyl maleimide, in particular acrylonitrile;
         wherein the sum of CB21+CB22 is 100% by weight; and
   wherein the sum of graft base CB1 and graft shell CB2 is 100% by weight;
and wherein the agglomerated graft base CB1 has a bimodal particle size distribution including a fraction of particles having a D₅₀ value in the range of 80 to 330 nm, preferably in the range of 80 to 150 nm, and a fraction of particles having a D₅₀ value in the range of from 340 to 550 nm, preferably in the range of 340 to 480 nm.

The particle size distribution, the weight mean average particle diameter D_{W} and the weight median average particle diameter D₅₀ can be determined using a ultracentrifuge (for example as described in W. Scholtan, H. Lange: Kolloid Z. u. Z. Polymere 250, pp. 782 to 796, 1972) or a disc centrifuge (for example DC 24000 by CPS Instruments Inc.). The weight mean average particle diameter D_{w} (or De Broucker mean particle diameter) is an average size based on unit weight of particle. The definition for the weight mean average particle size diameter D_{w} can be given as:

$${D}_{W} = sum ( {n}_{i} * {D}_{i}^{4} ) / sum ( {n}_{i} * {D}_{i}^{3} )$$

nᵢ: number of particles with the diameter Dᵢ
   (see G. Lagaly, O. Schulz, R. Ziemehl: Dispersionen und Emulsionen: Eine Einführung in die Kolloidik feinverteilter Stoffe einschließlich der Tonminerale, Darmstadt: Steinkopf-Verlag 1997, ISBN 3-7985-1087-3, pages 279 to 283, formula 8.3b). The weight median diameter D₅₀ represents the diameter at which 50% by weight of the particles are less in size.

In particular, preferred embodiments of graft base CB1 are described in DE-A 10 2005 022632, examples S₁₁ to S₁₃, and WO 2014/170406, example B1. In particular, preferred embodiments of agglomerating copolymer CP are described in WO 2008/020012, examples 3.1a to 3.1h, and WO 2014/170406A1, examples C-1 and C-2. Preferably, the graft copolymer CB as described in WO 2014/170406, see “Pfropfcopolymer B, Allgemeine Vorgehensweise”, pp 34-35, is used according to the present invention.

The molding composition can also comprise two or more different graft copolymers CB. In a preferred embodiment the graft copolymer CB is a mixture of at least two graft copolymers CB-I and CB-II, wherein
the graft copolymer CB-I is obtained via emulsion polymerization of a mixture of the monomers CB21 and CB22 in the presence of a graft base CB1-I, which has an particle diameter D₅₀ in the range of 80 to 330 nm,
and graft copolymer CB-II is obtained via emulsion polymerization of a mixture of the monomers CB21 and CB22 in the presence of a graft base CB1-II, which has an particle diameter D₅₀ in the range of 340 to 480 nm.

The at least one graft copolymer CB is present in the thermoplastic molding composition in an amount of at least 5% by weight, preferably at least 15% by weight, more preferably at least 25% by weight, most preferably at least 30% by weight, based on the total thermoplastic molding composition.

### Thermoplastic Copolymer CA

The thermoplastic copolymer CA is free of any latex type polymer (rubber free) and comprises at least 50% by weight of one or more vinyl aromatic monomer(s) CA11, in particular styrene and/or α-methyl styrene, and mixtures of monomer CA11, with at least one other co-monomer CA12, in particular at least one vinyl cyanide monomer.

Preferably, the vinyl aromatic monomer(s) CA11 are selected from styrene and α-methyl styrene, in particular styrene.

Preferably, the at least one other co-monomer CA12 is at least one vinyl cyanide monomer (as co-monomer CA12).

Preferably, the thermoplastic copolymer CA comprises at least 50% by weight of one or more vinyl aromatic monomer(s) CA11, in particular styrene and/or α-methyl styrene, and up to 50% by weight of one or more other co-monomer CA12, in particular vinyl cyanide monomer.

In particular, the at least one thermoplastic copolymer CA, can be selected from polystyrene, copolymers of styrene such as styrene acrylonitrile copolymers, copolymers of α-methyl styrene such as α-methyl styrene acrylonitrile copolymers.

Preferably, thermoplastic copolymer CA comprises (or consists of) at least one vinyl aromatic monomer CA11, preferably selected from styrene and α-methylstyrene in an amount of 69 to 81% by weight, preferably 70 to 76% by weight, more preferably 72 to 76% by weight, and at least one vinyl cyanide monomer CA12, preferably acrylonitrile and/or methacrylonitrile, in an amount of 19 to 31% by weight, preferably 24 to 30% by weight, more preferably 24 to 28% by weight.

In a preferred embodiment, the thermoplastic copolymer CA is a SAN copolymer (CA-1) composed of the monomers CA11 and CA12, wherein the at least one vinyl aromatic monomer CA11 is selected from styrene, α-methyl styrene, and mixtures thereof, and the at least one vinyl cyanide monomer CA12 is acrylonitrile.

Typically, the number-average molar mass (Mₙ) of the thermoplastic copolymer CA amounts from 15,000 to 100,000 g/mol (determined by means of GPC with UV detection). The viscosity (Vz) of the thermoplastic copolymer CA may be for example in the range of 50 to 120 ml/g (measured to DIN 53726 at 25° C. in a 0.5% strength by weight solution in DMF).

The thermoplastic copolymer CA can be prepared by all known methods, for example bulk polymerization, solution polymerization, suspension polymerization and emulsion polymerization or mixed process, e.g. mass/suspension polymerizations, with or without further components. More preferably, the thermoplastic copolymer CA is prepared from the components acrylonitrile and styrene and/or α-methylstyrene via bulk polymerization or in the presence of one or more solvents, for example, toluene or ethylbenzene. A polymerization process is for example described in Kunststoff-Handbuch [Plastics Handbook], Vieweg-Daumiller, volume V, (Polystyrol) [Polystyrene], Carl-Hanser-Verlag, Munich 1969, pages 122 et seq.

### Phenolic Stabilizer A and Thio Co-Stabilizer B

The two or more phenolic stabilizers A are selected from the group consisting of:
A2: Octadecyl 3-(3,5-di-tert-butyl-4-hydroxyphenyl)propionate (CAS Number: 2082-79-3) with the restriction that when A2 is applied, always A3 and/or A4 must be present;
A3: Benzenepropanoic acid, 3,5-bis(1,1-dimethylethyl)-4-hydroxy-, 1,1′-(thiodi-2,1-ethanediyl) ester (CAS Number: 41484-35-9);
A4: 2,4,6-Tris(3′,5′-di-tert-butyl-4′-hydroxybenzyl)mesitylene (CAS Number: 1709-70-2).

Preferred phenolic stabilizers A are a combination of the phenolic stabilizers A2 and A3. Further preferred phenolic stabilizers A are a combination of the phenolic stabilizers A2 and A4.

Furthermore, preferred phenolic stabilizers A are a combination of the phenolic stabilizers A2, A3 and A4.

According to a further embodiment, the phenolic stabilizers A are a combination of the phenolic stabilizers A3 and A4.

In the context of the instant invention, a combination of stabilizers (i.e. a combination of phenolic stabilizers A, a combination of thio co-stabilizers B, and/or a combination of phenolic stabilizers A and thio co-stabilizers B) has the meaning of a) a mixture of two or more stabilizer components, and/or B) the combination of stabilizers is obtained by addition of the two or more stabilizer components at different production or processing steps in separate feed streams to the graft copolymer CB, the ABS polymer compound (graft copolymer CB and optionally thermoplastic copolymer CA) and/or the blends of the ABS polymer compound with PC, PEC and/or PA, or γ) a combination of both meanings.

When combinations of the phenolic stabilizers such as A2 with A3, or A2 with A4, or A2 with A3 and A4, are applied, then the preferred amount of A2 is always higher than A3 or A4, or the sum of A3 and A4.

Preferred is a combination of phenolic stabilizers A2 and A3 in a weight (percent) ratio A2:A3 of 95 to 55:5 to 45, preferably 90 to 60:10 to 40, more preferably 85 to 65:15 to 35. Moreover, often a combination of phenolic stabilizers A2 and A3 in a weight (percent) ratio A2:A3 of 80 to 65:20 to 35 is used.

Furthermore preferred is a combination of phenolic stabilizers A2 and A4 in a weight (percent) ratio A2:A4 of 95 to 55:5 to 45, preferably 90 to 60:10 to 40, more preferably 85 to 65:15 to 35. Moreover, often a combination of phenolic stabilizers A2 and A4 in a weight (percent) ratio A2:A4 of 80 to 65:20 to 35 is used.

Furthermore preferred is a combination of phenolic stabilizers A2, A3 and A4 in a weight ratio A2:(A3+A4) of 95 to 55:5 to 45, preferably 90 to 60:10 to 40, more preferably 85 to 65:15 to 35. Moreover, often a combination of phenolic stabilizers A2, A3 and A4 in a weight (percent) ratio A2:(A3+A4) of 80 to 65:20 to 35 is used.

According to a further embodiment, a combination of phenolic stabilizers A3 and A4 is used in a weight ratio A3:A4 of 90 to 10:10 to 90, preferably 80 to 20:20 to 80, more preferably 70 to 30:30 to 70.

The phenolic stabilizers A are combined with at least one thio co-stabilizer B which is preferably a sulfide compound selected from the group consisting of
B1: Dilauryl thiodipropionate (CAS Number: 123-28-4);
B2: Distearyl thiodipropionate (CAS Number: 693-36-7);
B3: Dimyristyl thiodipropionate (CAS Number: 16545-54-3);
B4: 2,4-Bis(n-octylthio)-6-(4′-hydroxy-3′,5′-di-tert-butylanilino)-1,3,5-triazine (CAS Number: 991-84-4);
B5: Trimethylolpropane tris(octyl thiodipropionate);
B6: Trimethylolethane tris(octyl thiodipropionate);
B7: Ethylene glycol bis(lauryl thiodipropionate);
B8: Didodecyl monosulfide.

Preferred thio co-stabilizers B are B1 and/or B2, in particular preferred is B1.

As described for stabilizer combinations above, the phenolic stabilizers A and the at least one thio co-stabilizer B can be added during the production and processing steps individually, partly mixed or completely mixed in at least one or more feed streams to the graft rubber copolymer CB, the ABS polymer compound (graft copolymer CB and optionally thermoplastic copolymer CA) and/or blends of the ABS polymer compound with PC, PEC and/or PA.

Preferred combinations of phenolic stabilizers A and the thio co-stabilizer B are:
A2 and A3 and B1 and/or B2, preferably A2 and A3 and B1;
A2 and A4 and B1 and/or B2, preferably A2 and A4 and B1;
A2 and A3 and A4 and B1 and/or B2, preferably A2 and A3 and A4 and B1.

A stabilizer dispersion is needed to stabilize the graft copolymer CB against oxidation and discoloration during the work up which is
precipitation of the graft copolymer CB by adding a precipitation solution comprising at least one salt,
mechanical dewatering (e.g. by filtration or centrifugation), optional washing and/or optional drying of the precipitated graft copolymer CB.

Suitable methods for drying the precipitated graft copolymer CB are drying with hot air in a flash dryer or fluidized bed dryer or a combination of both to achieve a dry graft copolymer CB or drying the wet graft copolymer CB in a kneader or extruder together with a SAN copolymer melt.

The preparation of a stabilizer dispersion S can be performed according to DE 199 46 519 A1 or WO 2017/211783 A1, but it is not limited to the methods or procedures described there.

According to the invention, a stabilizer dispersion S is obtained by a process comprising the following steps, the order of step ii) to v) can be changed:
i) providing an aqueous composition, preferred water;
ii) adding at least one surfactant C to the aqueous composition obtained in step i);
iii) optionally adding at least one thio co-stabilizer B to the aqueous composition obtained in step ii), wherein the temperature of the aqueous composition is higher than or equal to the melting point of the at least one thio co-stabilizer B;
iv) adding at least one, often two or more, of the phenolic stabilizers A2, A3 or A4, preferably a combination of phenolic stabilizers A2 and A3, or, a combination of phenolic stabilizers A2 and A4, or further preferred phenolic stabilizer A2 alone, to the aqueous composition obtained in step ii) or iii), wherein the temperature of the aqueous composition is higher than or equal to the melting point of the optionally at least one thio co-stabilizer B, at least 40° C.;
v) optionally adding at least one silicon oil component D;
vi) homogenization of the aqueous composition obtained in steps ii) to v) for producing a stabilizer dispersion S.

The homogenization of the aqueous composition obtained in steps ii) to v) may be achieved by e.g. passing the aqueous composition at least once through at least one homogenization device, preferably at least once through at least one homogenization nozzle, whereby a stabilizer dispersion S, consisting of an continuous phase and at least one disperse phase, is obtained. Alternatively, any other suitable homogenization device which provides high shear forces, like rotor-stator-mixers or a bead mill can be applied.

In case that the disperse phase is solid under the conditions of the processing, a bead mill process may preferably be applied.

Often, as homogenization device a rotor-stator-mixer is used.

The following stabilizer dispersions S are preferred:
1) Stabilizer dispersion of component A2.
2) Stabilizer dispersion of component A3.
3) Stabilizer dispersion of component A4.
4) Stabilizer dispersion of a mixture of component A2 and A3.
5) Stabilizer dispersion of a mixture of component A2 and A4.
6) Stabilizer dispersion of a mixture of component A2, A3 and A4.
7) Stabilizer dispersion of a mixture of component A2 and B1 and/or B2, preferably A2 and B1.
8) Stabilizer dispersion of a mixture of component A3 and B1 and/or B2, preferably A3 and B1.
9) Stabilizer dispersion of a mixture of component A4 and B1 and/or B2, preferably A4 and B1.
10) Stabilizer dispersion of a mixture of component A2 and A3 and B1 and/or B2, preferably A2 and A3 and B1.
11) Stabilizer dispersion of a mixture of component A2 and A4 and B1 and/or B2, preferably A2 and A4 and B1.
12) Stabilizer dispersion of a mixture of component A2, A3 and A4 and B1 and/or B2, preferably A2, A3 and A4 and B1.

The at least one phenolic stabilizer A comprised in the stabilizer dispersion S is preferably used in an amount from 0.1 to 65% by weight, preferably 1 to 60% by weight, particularly preferably from 10 to 30% by weight, most preferably from 15 to 30% by weight, based on the total weight of the stabilizer dispersion S.

If present, in the stabilizer dispersion S, at least one thio co-stabilizer B is preferably used in an amount from 0.1 to 65% by weight, preferably 1 to 60% by weight, particularly preferably from 10 to 40% by weight, most preferably from 20 to 40% by weight, based on the total weight of the stabilizer dispersion S.

Optionally at least one silicon oil component D is used during the preparation of the stabilizer dispersion S.

The amount of water in the stabilizers dispersion S may by adjusted to sum up to 100 wt.-% with the further constituents.

For the preparation of the stabilizer dispersions S at least one surfactant C is applied.

A surfactant is a compound reducing the surface tension of the aqueous phase and/or a protective colloids that helps to stabilize a dispersion, in particular a suspension, an emulsion or a suspoemulsion against sedimentation.

The at least one surfactant C is preferably used in an amount from 0.1 to 20% by weight, preferably 0.5 to 15% by weight, particularly preferably from 1 to 10% by weight, most preferably from 1 to 5% by weight, based on the total weight of the stabilizer dispersion S.

Suitable surfactants C are surface-active agents or protective colloids commonly known for the preparation of emulsions and suspensions, in particular of aqueous emulsions and suspensions. Mixtures of surface-active agents and/or protective colloids may also be used.

Examples of suitable protective colloids are polyvinyl alcohols, cellulose derivatives, and copolymers containing vinylpyrrolidone. A detailed description of other suitable protective colloids is found in Houben-Weyl, Methoden der organischen Chemie, Vol. XIV/1, Makromolekulare Stoffe, Georg-Thieme-Verlag, Stuttgart, 1961, pp. 411-420.

The surface-active agents used as surfactant C are preferably exclusively compounds, which, unlike the protective colloids, usually have relative molecular weights below 2,000 g/mol. They may be either anionic, cationic, or non-ionic in nature. When mixtures of surface-active agents are used, the individual components have to be mutually compatible, and in the case of doubt, this can be checked using a few preliminary experiments. Examples of suitable surface-active agents are ethoxylated mono-, di-, and trialkylphenols having from 4 to 9 carbon atoms in the alkyl radical and an degree of ethoxylation (EO index) from 3 to 50, ethoxylated fatty alcohols having from 8 to 36 carbon atoms in the alkyl radical and an EO index from 3 to 50, fatty alcohol sulfonates, sulfosuccinates, ether sulfonates, resin soaps, and also the alkali metal or ammonium salts of alkylsulfonates having from 8 to 12 carbon atoms in the alkyl radical, and salts of higher fatty acids having from 10 to 30 carbon atoms in the alkyl radical. Other suitable emulsifiers are found in Houben-Weyl, Methoden der organischen Chemie, Vol. XIV/1, Makromolekulare Stoffe, Georg-Thieme-Verlag, Stuttgart, 1961, pp. 192-206.

Other suitable anionic surface-active agents are bis(phenylsulfonic acid) ethers and their alkali metal or ammonium salts, where these bear a C₄-C₂₄-alkyl group on one or both aromatic rings. These compounds are disclosed by way of example in U.S. Pat. No. 4,269,749.

Preferably, the at least one surfactant C is a compound selected from sodium or potassium salts of arylalkyl- or alkylsulfonates or of fatty acids having from 10 to 18 carbon atoms.

In a preferred embodiment, the surfactant C is selected alkylsulfonates, arylalkyl-sulfonates, fatty acids, and sodium and potassium salts thereof. More preferable the at least on surfactant C is selected from fatty acids, in particular fatty acids having a aliphatic hydrocarbon chain of 10 to 30, preferably 10 to 18, carbon atoms and sodium and potassium salts thereof. More preferably, the surfactant C is at least one fatty acid selected from oleic acid, stearic acid, palmitic acid and sodium and potassium salts thereof.

In another preferred embodiment, the surfactant C or the active form of the surfactant C is prepared in situ from an alkylsulfonate, arylalkylsulfonate or a fatty acid with an alkali metal hydroxide by conversion into the corresponding salt, which is active as surfactant in the dispersion. Instead of alkali metal hydroxides, it is also possible to use alkali metal carbonates or alkali metal hydrogen carbonates. Preferably, the at least one surfactant C is at least one fatty acid, preferably selected from oleic acid, stearic acid and palmitic acid, which is converted into the corresponding sodium or potassium salt.

The two or more phenolic stabilizers A comprised in the molding composition obtained by the process according to the invention are added in step x) (i.e. iv)) and further in optional step prexiii′) or step xiv) of the process according to the invention.

The total amount of the two or more phenolic stabilizers A is 0.002 to 5% by weight, preferably 0.01 to 3% by weight, more preferably 0.1 to 1% by weight, based on the total thermoplastic molding composition. The amounts of the phenolic stabilizers A used in each of the afore-mentioned process steps x) (i.e. iv)) and prexiii′), or, x) (i.e. iv)) and xiv) are summed up to 100% by weight, based on the total amount of phenolic stabilizer A.

The at least one thio co-stabilizer B comprised in the molding composition obtained by the process according to the invention is optionally added in step x) (i.e. iii)) of the process to the aqueous composition for obtaining stabilizer composition S, and further in optional step prexiii′) or step xiv) of the process according to the invention.

The total amount of the at least one thio co-stabilizer B is 0.002 to 5% by weight, preferably 0.01 to 3% by weight, more preferably 0.1 to 1% by weight, based on the total thermoplastic molding composition. The amounts of the thio co-stabilizer B used in each of the afore-mentioned process steps x) (i.e. iii)) and prexiii′), or, x) (i.e. iii)) and xiv) are summed up to 100% by weight, based on the total amount of thio co-stabilizer B.

Preferably—in steps xiii) and xiv) of the process according to the invention—at least one phenolic stabilizer A and optionally the at least one silicon oil component D are mixed in an extrusion or kneading process of the graft copolymer CB stabilized with a stabilizer dispersion S as dry powder or as wet powder with a rubber-free thermoplastic copolymer CA, e.g. a SAN copolymer, or further components K, e.g. further polymers such as PC, PEC and/or PA or blends of an ABS polymer compound with PC, PEC and PA.

Further preferred—in steps xiii) and xiv) of the process according to the invention—at least one phenolic stabilizer A and at least one thio co-stabilizers B and optionally at least one silicon oil component D are mixed in an extrusion or kneading process of the graft copolymer CB stabilized with a stabilizer dispersion S as dry or as wet powder with a rubber-free thermoplastic copolymer CA, e.g. a SAN copolymer, or further components K, e.g. further polymers such as PC, PEC and/or PA or blends of an ABS polymer compound with PC, PEC and PA.

The at least one phenolic stabilizer A, the thio co-stabilizer B, and if present, the silicon oil component D can be added individually or combined to the extrusion or kneading process.

According to the process of the invention (step prexiii′) it is also possible and preferred to provide a stabilized pre-mixture of a rubber-free thermoplastic copolymer CA, e.g. a SAN copolymer, with at least one of the stabilizers A, and the at least one thio co-stabilizer B and the optional silicon oil component D, which is then added (step xiii′) to the extrusion or kneading process of the graft copolymer CB stabilized with a stabilizer dispersion S as dry powder or as wet powder optionally with further components K, e.g. further polymers such as PC, PEC and/or PA.

In step prexiii′) of the inventive process it is also possible to first provide a mixture of the stabilizers A, B and the optional silicon oil component D with a rubber-free thermoplastic copolymer CA, e.g. a SAN copolymer, to produce a stabilizer masterbatch which is then mixed with further rubber-free thermoplastic copolymer CA, e.g. a SAN copolymer, to obtain said stabilized pre-mixture of a rubber-free thermoplastic copolymer CA. The stabilized pre-mixture may be produced by an extrusion or kneading process.

### Silicon Oil Component D

A silicon oil refers to a polymerized siloxane having organic side chains which can in particular described by the formula [R^{a}R^{b}SiO]ₒ with R^{a} and R^{b} being organic radicals, such as alkyl radicals. Preferably, the silicon oil component is selected from polydimethylsiloxanes, which may be linear or branched.

If present, the at least one silicon oil component D is preferably used in an amount from 0.1 to 40% by weight, preferably from 0.5 to 30% by weight, particularly preferably from 1 to 10% by weight, most preferably from 2 to 8% by weight, based on the total weight of the stabilizer dispersion S.

In a preferred embodiment, the silicon oil component D is polydimethylsiloxane of the following general formula (V):

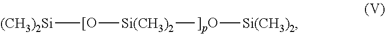

with p=integer number >1, preferably p=1 to 5,000.

Preferably, the kinematic viscosity of the silicon oil component D is the range of 100 mm²/s to 1,000,000 mm²/s, preferably in the range of 500 to 100,000 mm²/s.

Preferably, the silicon oil component used in the inventive process is a polydimethylsiloxane, CAS Reg. No. 63148-62-9 having a kinematic viscosity of 1,000 to 60,000 mm²/s.

For example, a suitable silicon oil component D used in the inventive process is one or more of the commercial available products Wacker Silicone Fluids AK 1000 (having a kinematic viscosity of 1,000 mm²/s), Wacker Silicone Fluids AK 30,000 (having a kinematic viscosity of 30,000 mm²/s) and Wacker Silicone Fluids AK 60,000 (having a kinematic viscosity of 60,000 mm²/s).

The at least one silicon oil component D comprised in the molding composition obtained by the process according to the invention is optionally added in step x) (i.e. v)) of the process for obtaining stabilizer composition S, and/or optionally in optional step prexiii) or optionally in step xiv) of the process according to the invention.

The total amount of the at least one silicon oil component D is up to 2% by weight, preferably 0.001 to 1% by weight, more preferably 0.01 to 0.2% by weight, based on the total thermoplastic molding composition. The amounts of the silicon oil D used in each of the afore-mentioned process steps x) (i.e. v)) and prexiii), or, x) (i.e. v)) and xiv) are summed up to 100% by weight, based on the total amount of silicon oil component D.

### Further Component K

In particular, the thermoplastic molding composition obtained by the process according to the invention may comprise 0 to 30% by weight, preferably 0 to 10% by weight, based on the total thermoplastic molding composition, of at least one further component K. More preferably the at least one further component K is present in an amount of 0.001 to 10% by weight, more preferably 0.01 to 5% by weight, based on the total thermoplastic molding composition.

The optional further component K may be selected from commonly known additives and/or auxiliaries for plastic materials. With respect to conventional auxiliaries and additives, reference is made by way of example to “Plastics Additives Handbook”, Ed. Gächter and Müller, 4th edition, Hanser Publ., Munich, 1996. For example, the at least one further component K may be selected from fillers, reinforcing agents, dyes, pigments, lubricants or mold-release agents, stabilizers for raising resistance to hydrolysis and to chemicals, light stabilizers, UV absorbers, plasticizers, impact modifiers, antistatic agents, flame retardants, bactericides, fungicides, optical brighteners, and blowing agents.

The optional at least one further component K is preferably selected from dyes, pigments, lubricants or mold-release agents, light stabilizers, antistatic agents, flame retardants and fillers, in particular mineral fillers.

Furthermore, it is possible that the thermoplastic composition comprises as further component K residues of the at least one surfactant C used for production of the stabilizer dispersion S as described above, selected from surface-active agents and protective colloids.

In another embodiment, the at least one further component K may be at least one further polymer selected from polycarbonates and polyamides.

Preferably, the further component K is at least one aromatic polycarbonate and/or at least one aromatic polyester carbonate. Aromatic polycarbonates and/or aromatic polyester carbonates, which may be suitable for the present invention, are described in the state of the art and may be prepared by known processes. In particular, the preparation of aromatic polycarbonate/aromatic polyester carbonate is carried out by reacting diphenols, preferably bisphenole A, carbonic acid halides, preferably phosgene, and optionally aromatic dicarboxylic acid halides, preferably benzenedicarboxylic acid halides. For example, suitable aromatic polycarbonates and aromatic polyester carbonate and their preparation are described in DE-A 2 714 544, DE-A 3 000 610, DE-A 3 832 396 and DE-A 3 077 934.

Preferably, the further component K is at least one polyamide selected from homopolyamides, copolyamides and mixtures of such polyamides. Suitable polyamides and methods for their production are known from the state of the art. In particular, suitable semi-crystalline polyamides are polyamide-6, polyamide-6,6, mixtures and corresponding copolymers of those components.

Also included are polyamides wherein the acid component consists wholly or partially of terephthalic acid and/or isophthalic acid and/or suberic acid and/or sebacic acid and/or azelaic acid and/or adipic acid and/or cyclohexanedicarboxylic acid, the diamine component consists wholly or partially of m- and/or p-xylylene-diamine and/or hexamethylenediamine and/or 2,2,4-trimethylhexamethylenediamine and/or 2,2,4-trimethylhexamethylenediamine and/or isophoronediamine, In particular, amorphous polyamides can be used as further component K, which are obtained by polycondensation of diamines, such as ethylenediamine, hexamethylenediamine, decamethylenediamine, 2,2,4- and/or 2,4,4-trimethylhexamethylenediamine, m- and/or p-xylylene-diamine, bis-(4-aminocyclohexyl)-methane, bis-(4-aminocyclohexyl)-propane, 3,3′-dimethyl-4,4′-diamino-dicyclohexylmethane, 3-aminomethyl-3,5,5-trimethylcyclohexylamine, 2,5- and/or 2,6-bis-(aminomethyl)-norbornane and/or 1,4-diaminomethylcyclohexane, with dicarboxylic acids such as oxalic acid, adipic acid, azelaic acid, azelaic acid, decanedicarboxylic acid, heptadecanedicarboxylic acid, 2,2,4- and/or 2,4,4-trimethyladipic acid, isophthalic acid and terephthalic acid.

Examples that may be mentioned of fillers, which may be selected from particulate fillers or reinforcing agents, are silicates, amorphous silica, calcium silicates, such as wollastonite, powdered quartz, mica, metal oxides, metal hydroxides, carbon black, graphite, barium sulfate, calcium carbonate, magnesium carbonate, bentonites, talc, kaolin, carbon fibres or glass fibres in the form of glass woven, glass mats, or glass silk rovings, chopped glass, or glass beads. In particular, at least one particulate fillers, preferably a mineral filler, can be used as further component K.

Examples of suitable pigments are titanium dioxide, phthalocyanines, ultramarine blue, iron oxides, or carbon black, and also the entire group of organic pigments.

Common stabilizers for thermoplastic polymers encompass light stabilizers (stabilizers for increasing lightfastness) and stabilizers for raising resistance to hydrolysis and to chemicals. Examples of suitable light stabilizers are various substituted resorcinols, salicylates, benzotriazoles, and benzophenones. HALS stabilizers (Hindered Amine Light Stabilizers), benzophenones, resorcinols, salicylates, and benzotriazoles are also suitable.

Examples of suitable antistatic agents are amine derivatives, such as N,N-bis(hydroxyalkyl)alkylamines or -alkyleneamines, alkylsulfonates, polyethylene glycol esters, copolymers composed of ethylene oxide glycol and of propylene oxide (in particular two-block or three-block copolymers in each case composed of ethylene oxide blocks and of propylene oxide blocks) glycol, and glycerol mono- and distearates, and also mixtures of these.

Suitable lubricants or mold-release agents are fatty acids having from 12 to 30 carbon atoms, salts and derivatives thereof, for example stearic acid and stearates, stearyl alcohol, stearic esters, amide waxes (e.g. stearamides, in particular ethylene bis(stearamide) (EBS)), and polyolefin waxes. Particularly suitable lubricants and mold-release agents are stearic acid, stearates (e.g. magnesium stearate), ethylene bis(stearamide) (e.g. Irgawax®, Ciba, Switzerland) and mixtures thereof. Preferably, the thermoplastic molding composition comprises 0.05 to 5% by weight, preferably 0.1 to 3% by weight, based on the total thermoplastic molding composition, of at least one lubricant or mold-release agents, more preferably ethylene bis(stearamide) and/or magnesium stearate. In a preferred embodiment the thermoplastic molding composition comprises 0.1 to 5% by weight, based on the total thermoplastic molding composition, ethylene bis(stearamide) and 0.05 to 1% by weight, based on the total thermoplastic molding composition, magnesium stearate.

### Thermoplastic Molding Composition

A further aspect of the invention are thermoplastic molding compositions obtained by the process according to the invention.

Preferably obtained by the process according to the invention are thermoplastic molding compositions comprising:
5 to 80% by weight thermoplastic thermoplastic copolymer CA;
15 to 60% by weight graft copolymer CB;
0.01 to 3% by weight, preferably 0.1 to 1% by weight, of two or more phenolic stabilizers A;
0.01 to 3% by weight, preferably 0.1 to 1% by weight, of at least one thio co-stabilizer B;
0.001 to 1% by weight, preferably 0.01 to 0.2% by weight, based on the total thermoplastic molding composition, of at least one silicon oil component D;
0 to 10% by weight, preferably 0.01 to 1% by weight, based on the total thermoplastic molding composition, of at least one further component K.

In a preferred embodiment, the amounts of the components CA, CB, A, B, D and optional K are summed up to 100% by weight. In particular, the amount of the graft copolymer CB can adapted so that the sum of the compounds results in 100% by weight.

The thermoplastic molding composition obtained by the process according to the invention may be based on commonly known blends of ABS polymer compounds (blend of rubber free thermoplastic copolymer CA and graft copolymer CB) with polycarbonates PC, polyestercarbonates PEC or polyamides PA, such as ABS/PC or ABS/PEC or ABS/PA.

### Process for the Preparation of a Thermoplastic Molding Composition

The process according to the invention for producing a thermoplastic molding composition encompasses step x) adding a stabilizer dispersion S to the graft copolymer CB after its emulsion polymerization. In particular, this means that the aqueous stabilizer dispersion S is added to the graft copolymer CB, which is in form of an aqueous latex.

Preferably, the stabilizer dispersion S is added to the graft copolymer CB after its emulsion polymerization in step x) in an amount of often 0.05 to 3% by weight, preferably 0.1 to 1.5% by weight, based on the solid contents of the stabilizer dispersion S/solid content of the graft copolymer latex CB (i.e. % by weight of solids of stabilizer dispersion S/% by weight solids of graft copolymer CB).

Corresponding to the definition of the solid content of the stabilizer dispersion S the solid content of the graft copolymer (res. the graft copolymer latex or the precipitated graft copolymer obtained in step xi) refers to and is equal to the weight content of the non-volatile compounds in the graft copolymer. The solid content is in particular equal to the solid content determined gravimetrically by removing the volatile compounds (in particular water), for example by evaporation at 150 to 180° C. for about 10 to 120 min in a drying cabinet.

Typically, at least one aqueous stabilizer dispersion S as described above is mixed with the graft copolymer CB after its emulsion polymerization under stirring.

The inventive process for producing a thermoplastic molding composition encompasses step xi) the precipitation of the graft copolymer CB obtained in step x) (including the stabilizer dispersion S) by adding a precipitation solution comprising at least one salt. Typically, the graft copolymer CB obtained in step x) is precipitated using a precipitation solution comprising at least one salt or at least one salt and at least one acid. Preferred salts are selected from magnesium sulfate, calcium chloride, magnesium sulfate mono-hydrate (kieserite Mg[SO₄]·H₂O), magnesium sulfate pentahydrate (pentahydrate Mg[SO₄]·5H₂O), magnesium sulfate hexahydrate (hexahydrite Mg[SO₄]·6H₂O) and magnesium sulfate heptahydrate (epsomite (Mg[SO₄]·7H₂O). Preferred acids are selected from sulfuric acid, phosphoric acid, and acetic acid.

In a preferred embodiment step xi) encompasses the precipitation of the graft copolymer CB obtained in step x), by adding a precipitation solution comprising at least one salt and at least one acid. Preferably, the precipitation solution is firstly provided, e.g. in a precipitation tank, following the graft copolymer CB (mixture of graft copolymer CB and stabilizer dispersion S) is added into the precipitation solution under stirring, and afterwards the obtained precipitation mixture is heated up.

Typically, the precipitation solution used in the inventive process is prepared by mixing water with at least one salt or a saturated solution of the salt and/or at least one acid. Typically, the precipitation solution comprises 0.1 to 5% by weight, preferably 0.2 to 1% by weight of the at least one salt and/or at least one acid.

Preferably, the amount of the at least one salt and/or at least one acid (e.g. magnesium sulfate and/or sulfuric acid (96% by weight)) is used in such way that the concentration of the at least one salt and/or the at least one acid is in the range of 0.01 to 1% by weight, preferably in the range of 0.05 to 0.7% by weight, based on the total aqueous phase of the precipitation mixture. More preferably the amount of the at least one salt is used in such way that the concentration of the at least one salt is in the range of 0.1 to 1% by weight, preferably in the range of 0.2 to 0.75% by weight, based on the total aqueous phase of the precipitation mixture. More preferably the amount of the at least one acid is used in such way that the concentration of the at least one acid is in the range of 0.01 to 0.5% by weight, preferably in the range of 0.02 to 0.1% by weight, based on the total aqueous phase of the precipitation mixture. The precipitation mixture typically refers to the mixture of graft copolymer CB obtained in step x) (res. the mixture of graft copolymer CB and stabilizer dispersion S) and the precipitation solution.

Typically, the precipitation in step xi) is carried out at temperatures in the range of 40° C. to 150° C., preferably 60 to 95° C. In a preferred embodiment step xi) is carried out by adding the graft copolymer CB (including the stabilizer dispersion S) obtained in step x) into the precipitation solution under stirring.

Preferably, the solid content of the graft copolymer CB (including stabilizer dispersion S) used in precipitation step xi) is in the range of 5 to 30% by weight, preferably 10 to 25% by weight, more preferably 15 to 20% by weight.

Preferably, the solid content of the precipitated dispersion obtained in the precipitation step xi) (which can be regarded as a mixture of graft copolymer CB, including stabilizer dispersion S, and precipitation solution) is in the range of 5 to 20% by weight, more preferably in the range of 10 to 15% by weight.

The process for producing a thermoplastic molding composition according to the invention encompasses step xii) of mechanical dewatering, optional washing and/or optional drying of the precipitated graft copolymer CB obtained in step xi).

Typically, the precipitated graft copolymer CB is at least partially dewatered in particular by centrifugation and/or filtration. Preferably, the precipitated graft copolymer CB is at least partially mechanically dewatered and separated from the aqueous phase using a centrifuge.

Typically, the graft copolymer CB obtained after mechanical dewatering has a residual moisture level in the range of 10 to 50% by weight, preferably 20 to 40% by weight, more preferably 25 to 35% by weight.

The residual moisture level refers to the amount of water given in % by weight, based on the total wet graft copolymer CB. Typically, the residual moisture level can be determined using suitable apparatuses, such as a drying scales. Typically, the sample is dried over a given period as long as a constant weight level is maintained. For example, the residual moisture level can be determined in an Halogen Moisture Analyzer HR73 from Mettler-Toledo, at 180° C., maintaining a constant weight for 30 seconds.

In a further preferred embodiment, the graft copolymer CB is washed once or several times after mechanical dewatering wherein the separated graft copolymer CB is brought in contact with water or a mixture of water and a polar organic solvent miscible with water (optional washing step). After washing the graft copolymer CB is typically separated from the water, e.g. by centrifugation.

Optional the dewatered or dewatered and washed graft copolymer CB may be dried, for example using a cabinet dryer or other common known drying apparatus, such as flash dryer or fluidized bed dryer. The graft copolymer CB can also be dried as described in DE-A 19907136. Typically, the optional drying step is carried out at a temperature in the range of 50 to 160° C.

Preferably, after step xii) the graft copolymer CB is in form of a dried polymer latex powder having a residual moisture level of less than 5% by weight, preferably less than 2% by weight, more preferably less than 1% by weight.

It is also suitable to mix graft copolymer CB in step xiii) in the form of moist crumb having a residual moisture level of from 1 to 40% by weight, in particular from 20 to 40% by weight, whereupon then the complete drying of the graft copolymers takes place during the mixing process (step xiii).

The inventive process for producing a thermoplastic molding composition encompasses the optional step prexiii) providing a thermoplastic copolymer CA, or the optional step prexiii′) providing a stabilized pre-mixture of a copolymer CA with at least one, often two or more, of the phenolic stabilizer A, preferably a combination of phenolic stabilizers A2 and A3, or a combination of phenolic stabilizers A2 and A4, or further preferred phenolic stabilizer A3 or A4 alone, and the at least one thio co-stabilizer B, and optionally the at least one silicon oil component D;

The inventive process for producing a thermoplastic molding composition further encompasses the optional step xiii) of mixing the graft copolymer CB obtained in step xii) with a thermoplastic copolymer CA as provided in optional step prexiii), and optional with further components K.

The inventive process for producing a thermoplastic molding composition further encompasses the optional step xiii′) of mixing the graft copolymer CB obtained in step xii) with the stabilized pre-mixture obtained in step prexiii′), and optionally with further components K.

Preferably, if the thermoplastic copolymer CA is present, step xiii) according to the process of the invention encompasses mixing of the thermoplastic copolymer CA and the graft copolymer obtained in step xii) and optional further components K.

Preferably, if the thermoplastic copolymer CA is present as the stabilized pre-mixture of thermoplastic copolymer CA obtained in step prexiii′), step xiii′) according to the process of the invention encompasses mixing of the stabilized pre-mixture of thermoplastic copolymer CA and the graft copolymer obtained in step xii) and optional further components K.

Methods and devices for mixing the graft copolymer CB with other polymers and/or other components selected from additives and auxiliaries as mentioned above are known by a skilled person. Typically, steps xiii) and xiii′) encompass melt-compounding and/or melt-extrusion and can typically be carried out using one or more kneaders, extruders and/or twin shaft screw.

Preferably, the mixing in step xiii) or xiii′) in particular the mixing of the dried graft copolymer CB, the thermoplastic copolymer CA or the stabilized mixture of thermoplastic copolymer CA, and optional further components K, is carried out at temperatures in the range of 200 to 300° C.

The mixing in step xiii) or xiii′) in particular the mixing of the dried graft copolymer CB, the thermoplastic copolymer CA or the stabilized mixture of thermoplastic copolymer CA and optional further components K, may be carried out successively or simultaneously. Furthermore it is suitable to mix some or all of the components at a temperature of 15 to 40° C., in particular at room temperature, in a first step, and afterwards raising the temperature up to 200 to 300° C., optionally under addition of further additives, in a second step.

In step xiv) of the process according to the invention the composition obtained in step xii) or xiii) is mixed with at least one, often two or more, of the phenolic stabilizer A, preferably a combination of phenolic stabilizers A2 and A3, or a combination of phenolic stabilizers A2 and A4, or further preferred phenolic stabilizer A3 or A4 alone, and the at least one thio co-stabilizer B, and optionally the at least one silicon oil component D.

Step xiv)—carried out in case step xiii′) is not present—may be a separate step but may also be included in step xiii) of the process according to the invention. Thus, it is referred to the process conditions (i.e. temperatures) as described for step xiii) hereinbefore.

According to a further embodiment no silicon oil D is added in optional step prexiii′) or in step xiv) of the inventive process. Thus, the total amount of silicon oil D, if present, is added in step x) by adding the stabilizer dispersion S. In this further embodiment of the invention further compounding steps can be reduced.

The thermoplastic compositions obtained by the process according to the invention can be used to produce formed parts by any commonly known method, e.g. injection molding, extrusion, blow molding. For example, the formed parts can be selected from plates, semi-manufactured products, films, fibres and foams. In particular, said molded parts can for example used in the automobile sector, e.g. in bodywork construction for vehicles, for the interior of automobiles. The moldings obtained by the process according to the invention can be employed, in particular, in the construction of ships, aircraft or trains, in particular as lining parts, undertray components, dashboards, shell construction for seats, bulkheads. Furthermore, nonautomotive applications of the moldings obtained by the process according to the invention are also conceivable, e.g. formwork plates, lining elements, supporting shells and casing components.

The invention is further illustrated by the examples and claims.

### EXPERIMENTAL EXAMPLES

### Example I. Preparation of Stabilizer Dispersions S

The following components are used for the production of stabilizer dispersions S
A: phenolic stabilizer A, see list
C: surfactant, potassium stearate,
E: demineralized water.

The solid contents of stabilizer dispersions S were measured by evaporation of the samples at 180° C. for 25 min in a drying cabinet.

List of phenolic stabilizers A:
A1: butylated reaction product of p-cresol and dicyclopentadiene according to formula (Ia) with n=1-3 (CAS Number: 68610-51-5)
A2: Octadecyl 3-(3,5-di-tert-butyl-4-hydroxyphenyl)propionate (CAS Number: 2082-79-3);
A3: Benzenepropanoic acid, 3,5-bis(1,1-dimethylethyl)-4-hydroxy-1,1′-(thiodi-2,1-ethanediyl) ester (CAS Number: 41484-35-9);
A4: 2,4,6-Tris(3′,5′-di-tert-butyl-4′-hydroxybenzyl)mesitylene (CAS Number: 1709-70-2).
A5: Pentaerythritol tetrakis(3-(3,5-di-tert-butyl-4-hydroxyphenyl)propionate) (CAS Number: 6683-19-8);
A6: 1,2-Di[-(3,5-di-tert-butyl-4-hydroxyp-henyl)propionyl]hydrazine (CAS Number: 32687-78-8);
A7: N,N′-Hexan-1,6-diylbis[3-(3,5-di-tert-butyl-4-hydroxyphenylpropionamid] (CAS Number: 23128-74-7);
A8: Benzenepropanoic acid, 3,5-bis(1,1-dimethylethyl)-4-hydroxy-, C₇₋₉-branched alkyl esters (CAS Number: 125643-61-0);
A9: 2,4-dimethyl-6-(1-methyl pentadecyl) phenol (CAS Number: 134701-20-5); WL8=A4
A10: Triethylene glycol bis(3-tert-butyl-4-hydroxy-5-methylphenyl)propionate (CAS Number: 36443-68-2);
A11: 1,3,5-tris(3,5-di-tert-butyl-4-hydroxybenzyl)-1,3,5-triazine-2,4,6(1H,3H,5H)-trione (CAS Number: 27676-62-6);
A12: 6,6′-di-tert-butyl-4,4′-butylidenedi-m-cresol (CAS Number: 85-60-9);
A13: 4-[[4,6-Bis(n-octylthio)-1,3,5-triazin-2-yl]amino]-2,6-di-tert-butylphenol (CAS Number: 991-84-4);
A14: 2-Methyl-4,6-bis(octylsulfanylmethyl)phenol (CAS Number: 110553-27-0);
A15: 2,2′-Dihydroxy-3,3′-di(alpha-methylcyclohexyl)-5,5′-dimethyl-diphenylmethane (CAS Number: 77-62-3);
A16: Benzenepropanoic acid, 3,5-bis(1,1-dimethylethyl)-4-hydroxy-, C₁₃₋₁₅ branched and linear alkyl esters (CAS Number: 171090-93-0);
A17: 1,3,5-tris[[4-tert-butyl-3-hydroxy-2,6-xylyl]methyl]-1,3,5-triazine2,4,6(1H,3H,5H)-trione (CAS Number: 40601-76-1);
A18: 4,4′,4″-(1-methylpropanyl-3-ylidene)tris(6-tert-butyl-m-cresol) (CAS Number: 1843-03-4).
   b. Stabilizer Dispersion S, General Description

Stabilizer dispersions S were prepared in accordance with DE 199 46 519 A1 using a rotor-stator mixer with a tip speed of 21 m/s.

55 parts of demineralized water and 5 parts of potassium stearate C are provided first at 60° C. in a glass baker and mixed with a stirrer. 40 parts of A is added to the provided mixture of water and soap at 80° C. and mixed with a stirrer followed by mixing with the rotor-stator-mixer with a tip speed of 21 m/s for 3 minutes.
Total batch size: 200.0 g
Solid content by theory: 45.0% by weight

Solid contents were measured and then adjusted to 45.0% by weight by addition of demineralized water. Under a light microscope particles in the range of 1 to 5 μm and minor amounts of some large particles in the range of 20 μm are visible.

Stabilizer dispersion S1 contains A1, S2 contains A2 and so forth (see table 1).

TABLE 1
Stabilizer Dispersions S1 to S18

| | Dispersion | | | | | | | | |
|---|---|---|---|---|---|---|---|---|---|
| | S1 | S2 | S3 | S4 | S5 | S6 | S7 | S8 | S9 |
| Stabilizer A | A1 | A2 | A3 | A4 | A5 | A6 | A7 | A8 | A9 |

| | Dispersion | | | | | | | | |
|---|---|---|---|---|---|---|---|---|---|
| | S10 | S11 | S12 | S13 | S14 | S15 | S16 | S17 | S18 |
| Stabilizer A | A10 | A11 | A12 | A13 | A14 | A15 | A16 | A17 | A18 |

### Example II: Preparation of ABS Graft Copolymers CB

The following mixture of two ABS rubber latexes was used as graft copolymer CB:
2352.9 g of a first graft rubber latex with a solid content of 34.0% by weight obtained by emulsion polymerization of 50% by weight of a mixture of styrene and acrylonitrile in a ratio of 73:27 by weight onto 50% by weight of a polybutadiene latex (calculated as solids of the polybutadiene latex) with a D₅₀ size of 125 nm using potassium peroxodisulfate as initiator and tert-dodecylmercaptane as chain transfer agent and
3191.5 g of a second graft rubber latex with a solid content of 37.6% by weight obtained by emulsion polymerization of 41% by weight of a mixture of styrene and acrylonitrile in a ratio of 73:27 by weight onto 59% by weight of a polybutadiene latex (calculated as solids of the polybutadiene latex) with a D₅₀ size of 340 nm using potassium peroxodisulfate as initiator and tert-dodecylmercaptane as chain transfer agent.

The mixing ratio of the first graft rubber latex to the second graft rubber latex was 40:60 by weight based on the solids content.

The latex of graft copolymer CB was mixed with each one of the stabilizer dispersions S1 to S18. The stabilizer dispersion was fed into the graft copolymer CB (which was an aqueous emulsion polymer) and stirred for 1 hour. Then the precipitation of the stabilized latex was performed by feeding this latex under stirring into a magnesium sulfate/sulfuric acid solution and heating up to 95° C. The final solid content of the precipitated dispersion was 12.5% by weight.

The amount of magnesium sulfate (100% by weight) and sulfuric acid (96% by weight) was used in such way that the concentration of magnesium sulfate was 0.5% by weight, based on the total aqueous phase (in the precipitation mixture) and the concentration of sulfuric acid (96% by weight) was 0.07% by weight, based on the total aqueous phase (in the precipitation mixture).

With specific values for the precipitation of the ABS graft copolymer CB1, the following amounts were used:

Demineralized water (10,981 g) was provided first then adding and solving of 55.23 g of magnesium sulfate (100% by weight) and 7.74 g of sulfuric acid (96% by weight). Afterwards the mixture of the graft rubber latexes and stabilizer dispersion S1 (0.444 g) was added under stirring and heating up to 95° C.

The ABS graft copolymers CB2 to CB18 were precipitated in the same manner using the stabilizer dispersions S2 to S18.

The mixture of graft copolymer CB and stabilizer dispersion was centrifuged, washed with water and dried to achieve residual humidity less than 1.0% by weight. An ABS graft rubber powder was obtained and used as graft copolymer CB in example III. The compositions of ABS graft copolymers are summarized in Table 2.

The invention is not limited to the use of graft copolymers CB according to the aforementioned example. A further example of suitable graft copolymers CB can be found in WO 2022/229335 (component B2/B, page 40, line 9 to page 42, line 26, but with the exception that not 72.9 parts dispersion of stabilizer Wingstay L (CAS No.: 68610-51-5) are added but one of the stabilizer dispersions S according to the invention).

The results are summarized in the following Table 2.

TABLE 2
Composition of the ABS graft copolymers CB1 to CB18

| | |
|---|---|
| ABS graft copolymer CB | CB1 to CB 18 |
| Stabilizer dispersion | S1 to S18 |
| Amount of stabilizer | 0.50 |
| dispersion [g] | |
| Amount of graft copolymer | 2000 |
| CB [g solids] | |
| A in graft copolymer CB | 0.010 |
| Powder [% by weight] | |

### Example III: Preparation and Characterization of Thermoplastic Molding Compositions

a. Styrene-Acrylonitrile Copolymer CA (SAN Copolymer)

A statistical copolymer from styrene (monomer CA11) and acrylonitrile (monomer CA12) with a ratio of polymerized styrene to acrylonitrile of 76:24 was produced by free radical solution polymerization. The SAN copolymer (thermoplastic copolymer CA) exhibited a melt flow rate (MVR) of 56 mL/10 min, determined at 220° C. and 10 kg load according to ISO 1133.

b. Compounding Thermoplastic Molding Compositions

The thermoplastic molding compositions TC1 to TC18 were produced by compounding and pelletized the compositions with a twin screw extruder ThermoFischer Process 11, 11 mm twin-screw, 40 L/D and 220 rpm.

2 gravimetric dosing devices (one for graft copolymer CB, one for the pre-mixture of all other components) were used temperature was set to 240° C. for the twin screw extruder.

The following components were used:
Thermoplastic copolymer CA: SAN copolymer prepared according to Example IIIa, 64.74% by weight;
Graft copolymer CB: one of the obtained stabilized ABS graft copolymer powders CB1 to CB18 according to Example II, 34.86% by weight
Phenolic stabilizer A: one of the phenolic stabilizers A1 to A18, 0.15% by weight;
Thio co-stabilizer B1: dilauryl thiodipropionate, 0.150% by weight;
Silicon oil D: polydimethylsiloxane with kinematic viscosity of 1,000 mm²/s; 0.1% by weight.

The total amount of all components is 3000 g.

Graft copolymer CB1 and phenolic stabilizer A1 are used in the thermoplastic molding compositions TC1; CB2 and A2 is used in TC2 and so forth.

Injection molding was performed on an Engel e-mac 50 device, with a mold that has a one-side polished plate with 80×80×2 mm dimensions with the thermoplastic compositions TC1 to TC18.

To access the short time stability, test specimen were injection molded at elevated temperatures (240° C., 260° C., 280° C.) with elongated residence time (see table 3) and the yellowness index and the gloss at 20° were investigated.

To access long time stability, test specimen were injection molded at standard conditions (see table 3) and plates were stored at 80° C. in an oven.

After storage at 80° C. for 0 h, 200 h, 400 h, 600 h, 800 h, 1000 h, the yellowness index and the gloss at 20° were investigated.

TABLE 3
Injection molding conditions for short and long time stability test

| | | | Short time | | Short time | | Short time | |
|---|---|---|---|---|---|---|---|---|
| | Longtime | | stability | | stability | | stability | |
| | storage | | test | | test | | test | |
| Parameter | tests | | @240° C. | | @260° C. | | @280° C. | |
| T(Heating | 240° C. / | | 240° C. / | | 260° C. / | | 280° C. / | |
| zones die, Z1, | 230° C. / | | 230° C. / | | 250° C. / | | 270° C. / | |
| Z2, Z3) | 220° C. / | | 220° C. / | | 240° C. / | | 260° C. / | |
| | 210° C. | | 210° C. | | 230° C. | | 250° C. | |
| T(mold) | 70° | C. | 70° | C. | 70° | C. | 70° | C. |
| Dose volume | 30 | cm³ | 30 | cm³ | 30 | cm³ | 30 | cm³ |
| Dose speed | 0.25 | m/s | 0.25 | m/s | 0.25 | m/s | 0.25 | m/s |
| Back pressure | 80 | bar | 80 | bar | 80 | bar | 80 | bar |
| Injection speed | 30 | cm³/s | 30 | cm³/s | 30 | cm³/s | 30 | cm³/s |
| Switchover | 10.5 | cm³ | 10.5 | cm³ | 10.5 | cm³ | 10.5 | cm³ |
| point | | | | | | | | |
| Injection time | 0.73 | s | 0.73 | s | 0.73 | s | 0.73 | s |
| Holding time | 8 | s | 8 | s | 8 | s | 8 | s |
| Holding | 500 | bar | 500 | bar | 500 | bar | 450 | bar |
| pressure | | | | | | | | |
| Cooling time | 20 | s | 87 | s | 87 | s | 87 | s |
| Cycle time | 32.8 | s | 100 | s | 100 | s | 100 | s |

### Measurement Parameters for the Yellowness Index YI:

Color measurement with spectrophotometer Konica Minolta Cm-2600d;
Investigation with standard illuminant C and standard observer 1964 (10°);
Investigation of XYZ-color of four samples per injection molding temperature at 4 similar placed positions;

In accordance to ASTM E313 averaging of the XYZ values of the 4 measurement points per sample and calculation of the yellowness index (YI) per sample with the following formula:

$$YI = 100 * ( 1.2871 ⋆ X - 1.0781 * Z ) / Y ;$$

The following values represent the average of the respective yellowness index of the four samples per injection molding temperature (240° C., 260° C., 280° C.).

Calculation of the difference of the thermoplastic molding compositions TC (TC2 to TC20) to TC1 (with phenolic stabilizer A1) which is the reference composition.

$$For short time test \text{:} Δ YI = [ YI ( TC 240 ° C . ) + YI ( TC 260 ° C . ) + YI ( TC 280 ° C . ) ] - [ YI ( TC 1 \; 240 ° C . ) - YI ( TC 260 ° C . ) - YI ( TC 280 ° C . ) ]$$

$$For long time test \text{:} Δ YI = [ YI ( TC 0 h ) + YI ( TC 200 h ) + YI ( TC 400 h ) + YI ( TC 600 h ) + YI ( TC 800 h ) + YI ( TC 1000 h ) ] - [ YI ( TC 10 h ) + YI ( TC 1 \; 200 h ) + YI ( TC 1 \; 400 h ) + YI ( TC 1 \; 600 h ) + YI ( TC 1 \; 800 h ) + YI ( TC 1 \; 1000 h ) ]$$

The surface gloss is measured by reflectance measurement according to ISO 2813 at an angle of 20° (reported are gloss units (GU)) at the same plates which were used to measure the yellowness index.

TABLE 4
Gloss measurements at 20° for short time test and rating

| | Gloss | Gloss | Gloss | Rating in |
|---|---|---|---|---|
| | for 240° C. | for 260° C. | for 280° C. | comparison |
| Sample | (GU) | (GU) | (GU) | to TC1 [*] |
| TC1 | 62.93 | 72.48 | 70.30 | reference |
| TC2 | 74.21 | 68.26 | 78.75 | + |
| TC3 | 79.34 | 79.92 | 81.23 | ++ |
| TC4 | 78.09 | 79.71 | 72.46 | + |
| TC5 | 77.66 | 65.34 | 59.54 | − |
| TC6 | 78.53 | 76.64 | 80.26 | ++ |
| TC7 | 78.74 | 82.01 | 83.33 | ++ |
| TC8 | 73.86 | 83.94 | 83.10 | ++ |
| TC9 | 80.21 | 83.69 | 74.09 | + |
| TC10 | 81.91 | 82.78 | 78.99 | ++ |
| TC11 | 85.53 | 83.31 | 74.28 | + |
| TC12 | 84.49 | 84.3 | 79.89 | ++ |
| TC13 | 78.58 | 80.12 | 77.41 | ++ |
| TC14 | 82.64 | 73.68 | 76.44 | + |
| TC15 | 80.48 | 72.61 | 65.21 | 0 |
| TC16 | 81.33 | 73.31 | 68.83 | 0 |
| TC17 | 73.67 | 66.06 | 67.89 | − |
| TC18 | 82.44 | 75.79 | 64.81 | 0 |

[*]
++ much better than TC1 with A1 (reference sample)
+ better than TC1 with A1 (reference sample)
0 similar as TC1 with A1 (reference sample)
− worse than TC1 with A1 (reference sample)

TABLE 5
Gloss measurements at 20° for long time test and rating

| | Gloss | Gloss | Gloss | Gloss | Gloss | Gloss | Rating in |
|---|---|---|---|---|---|---|---|
| Sam- | 0 h | 200 h | 400 h | 600 h | 800 h | 1000 h | comparison |
| ple | (GU) | (GU) | (GU) | (GU) | (GU) | (GU) | to TC1 [*] |
| TC1 | 61.49 | 34.36 | 35.91 | 35.78 | 36.78 | 36.94 | reference |
| TC2 | 85.55 | 53.71 | 53.73 | 51.43 | 55.33 | 54.28 | + |
| TC3 | 84.88 | 57.11 | 58.08 | 58.53 | 58.65 | 58.03 | + |
| TC4 | 84.69 | 59.34 | 55.13 | 58.46 | 58.85 | 59.00 | + |
| TC5 | 84.28 | 59.71 | 59.23 | 61.84 | 61.35 | 59.56 | + |
| TC6 | 84.23 | 58.95 | 59.48 | 61.00 | 60.38 | 59.19 | + |
| TC7 | 83.56 | 52.56 | 53.48 | 58.90 | 51.64 | 56.75 | + |
| TC8 | 84.80 | 57.90 | 60.16 | 61.05 | 60.56 | 59.91 | + |
| TC9 | 85.91 | 61.95 | 60.71 | 63.23 | 62.78 | 59.05 | + |
| TC10 | 85.30 | 57.49 | 55.85 | 58.24 | 57.66 | 57.70 | + |
| TC11 | 86.56 | 59.61 | 59.04 | 57.54 | 59.69 | 56.96 | + |
| TC12 | 85.94 | 57.90 | 58.40 | 58.00 | 57.46 | 58.14 | + |
| TC13 | 83.88 | 55.25 | 52.86 | 54.63 | 56.39 | 54.45 | + |
| TC14 | 58.41 | 23.21 | 26.30 | 33.86 | 30.74 | 30.56 | − |
| TC15 | 78.89 | 43.23 | 32.21 | 39.29 | 46.25 | 37.61 | 0 |
| TC16 | 82.14 | 50.26 | 47.04 | 51.46 | 51.86 | 51.04 | + |
| TC17 | 79.29 | 52.85 | 55.30 | 55.48 | 55.44 | 51.80 | + |
| TC18 | 78.99 | 49.45 | 43.93 | 49.20 | 48.58 | 50.79 | + |

[*]
+ better than TC1 with A1 (reference sample)
0 similar as TC1 with A1 (reference sample)
− worse than TC1 with A1 (reference sample)

TABLE 6
Measurement of ΔYI, rating ΔYI and rating gloss 20°
for the short and long time test and overall rating

| | Sample | | | | | | |
|---|---|---|---|---|---|---|---|
| | | ΔYI | Gloss | | ΔYI | Gloss | |
| | | rating | rating | | rating | rating | |
| | ΔYI | [**] | [*] | ΔYI | [***] | [*] | |
| | Test | | | | | | Overall |
| | short | short | short | long | long | long | rating |
| | time | time | time | time | time | time | [****] |
| TC1 | reference | | | | | | |
| TC2 | 1.04 | + | + | −1.43 | ++ | + | ++ |
| TC3 | −0.43 | ++ | ++ | 6.71 | + | + | + |
| TC4 | −1.5 | ++ | + | −4.17 | ++ | + | ++ |
| TC5 | 3.03 | 0 | − | 46.62 | − | + | − |
| TC6 | −1.61 | ++ | ++ | 32.23 | − | + | − |
| TC7 | 0.21 | + | ++ | 14.41 | 0 | + | 0 |
| TC8 | −0.07 | ++ | ++ | 6.58 | + | + | + |
| TC9 | −1.82 | ++ | + | 7.28 | + | + | + |
| TC10 | 0.22 | + | ++ | 23.54 | − | + | − |
| TC11 | 23.25 | − | + | 11.25 | 0 | + | − |
| TC12 | 0.09 | + | ++ | 11.17 | 0 | + | 0 |
| TC13 | 6.75 | − | ++ | 9.71 | 0 | + | 0 |
| TC14 | 3.8 | 0 | + | −6.59 | ++ | − | 0 |
| TC15 | 6.57 | − | 0 | 22.34 | − | 0 | − |
| TC16 | 2.04 | 0 | 0 | 0.27 | + | + | 0 |
| TC17 | 5.68 | − | − | 2.49 | + | + | − |
| TC18 | 1.35 | + | 0 | 18.8 | − | + | − |

[*]
++ much better than TC1 with A1 (reference sample)
+ better than TC1 with A1 (reference sample)
0 similar as TC1 with A1 (reference sample)
− worse than TC1 with A1 (reference sample)
[**]
++ better than TC1 with A1 (reference sample): ΔY < 0
+ similar as TC1 with A1 (reference sample): 0 < ΔYI < 2
0 slightly worse than TC1 with A1 (reference sample): 2 < ΔYI < 4
− much worse than TC1 with A1 (reference sample): ΔYI > 4
[***]
++ much better than TC1 with A1 (reference sample)
+ better than TC1 with A1 (reference sample)
0 similar as TC1 with A1 (reference sample)
− worse than TC1 with A1 (reference sample)
[****]
++ much better than TC1 with A1 (reference sample)
+ better than TC1 with A1 (reference sample)
0 similar as TC1 with A1 (reference sample)
− worse than TC1 with A1 (reference sample)

By testing this large number of phenolic stabilizers A, as a surprising result, only few phenolic stabilizers, namely phenolic stabilizers A2, A3 and A4, are better than the reference stabilizer A1.

The phenolic stabilizers A2, A3 and A4 were then tested in mixtures: A2 with A3, and A2 with A4.

The following stabilizer dispersions S19 to S24 were produced according to the general description in example I with a mixture of the phenolic stabilizer A2 and A3 or a mixture of the phenolic stabilizer A2 and A4.

TABLE 7
Stabilizer Dispersions S19 to S24

| | | ratio A2/A3 | ratio A2/A4 |
|---|---|---|---|
| Stabilizer Dispersion | Mixture A | % by weight | % by weight |
| S19 | A2 and A3 | 85/15 | |
| S20 | A2 and A3 | 70/30 | |
| S21 | A2 and A3 | 55/45 | |
| S22 | A2 and A4 | | 85/15 |
| S23 | A2 and A4 | | 70/30 |
| S24 | A2 and A4 | | 55/45 |

The ABS graft copolymers CB19 to CB24 were prepared according to example II and precipitated in the same manner using the stabilizer dispersions S19 to S24.

TABLE 8
Composition of the ABS graft copolymers CB19 to CB24

| | |
|---|---|
| ABS graft copolymer CB | CB19 to CB 24 |
| Stabilizer dispersion | S19 to S24 |
| Amount of stabilizer | 0.50 |
| dispersion [g] | |
| Amount of graft copolymer | 2000 |
| CB [g solids] | |
| A in graft copolymer CB | 0.010 |
| powder [% by weight] | |

One of the obtained stabilized graft copolymers CB19 to CB24 and a mixture of phenolic stabilizers A2 and A3 or A2 and A4 were used in the thermoplastic molding compositions TC19 to TC24. The details of the compositions are given by Table 9. The thermoplastic molding compositions TC19 to TC24 were produced and tested according to the thermoplastic molding compositions TC1 to TC18.
Thermoplastic copolymer CA: SAN copolymer prepared according to Example IIIa, 64.74% by weight;
Graft copolymer CB: one of ABS graft rubber powders CB19 to CB24, 34.86% by weight;
Phenolic stabilizers A2 and A3 or A2 and A4: 0.150% by weight; Thio co-stabilizer B1: dilauryl thiodipropionate, 0.150% by weight;
Silicon oil D: polydimethylsiloxane with a kinematic viscosity of 1,000 mm²/s; 0.100% by weight. The total amount of all components is 3000 g.

TABLE 9
Composition of the thermoplastic
molding compositions TC19 to TC24

| | % by | % by | % by | ratio A2/A3 or A2/A4 |
|---|---|---|---|---|
| TC | weight A2 | weight A3 | weight A4 | % by weight |
| TC19 | 0.1275 | 0.0225 | | 85/15 |
| TC20 | 0.1050 | 0.0450 | | 70/30 |
| TC21 | 0.0825 | 0.0675 | | 55/45 |
| TC22 | 0.1275 | | 0.0225 | 85/15 |
| TC23 | 0.1050 | | 0.0450 | 70/30 |
| TC24 | 0.0825 | | 0.0675 | 55/45 |

TABLE 10
Gloss measurements at 20° for short time test and rating

| | Gloss | Gloss | Gloss | Rating in |
|---|---|---|---|---|
| | for 240° C. | for 260° C. | for 280° C. | comparison |
| Sample | (GU) | (GU) | (GU) | to TC1 [*] |
| TC1 | 62.93 | 72.48 | 70.30 | reference |
| TC2 | 74.21 | 68.26 | 78.75 | + |
| TC3 | 79.34 | 79.92 | 81.23 | + |
| TC4 | 78.09 | 79.71 | 72.46 | + |
| TC19 | 84.26 | 81.89 | 79.11 | + |
| TC20 | 85.58 | 84.43 | 77.91 | + |
| TC21 | 80.71 | 82.18 | 79.95 | + |
| TC22 | 86.97 | 82.53 | 79.73 | + |
| TC23 | 83.42 | 78.90 | 78.05 | + |
| TC24 | 86.53 | 86.03 | 80.20 | + |

[*]
+ similar or better than TC1 with A1 (reference sample)
0 slightly worse than TC1 with A1 (reference sample)
− worse than TC1 with A1 (reference sample)

TABLE 11
Gloss measurements at 20° for long time test and rating

| | Gloss | Gloss | Gloss | Gloss | Gloss | Gloss | Rating in |
|---|---|---|---|---|---|---|---|
| | 0 h | 200 h | 400 h | 600 h | 800 h | 1000 h | comparison |
| Sample | (GU) | (GU) | (GU) | (GU) | (GU) | (GU) | to TC1 [*] |
| TC1 | 61.49 | 34.36 | 35.91 | 35.78 | 36.78 | 36.94 | reference |
| TC2 | 85.55 | 53.71 | 53.73 | 51.43 | 55.33 | 54.28 | + |
| TC3 | 84.88 | 57.11 | 58.08 | 58.53 | 58.65 | 58.03 | + |
| TC4 | 84.69 | 59.34 | 55.13 | 58.46 | 58.85 | 59.00 | + |
| TC19 | 84.54 | 57.43 | 58.05 | 56.75 | 58.48 | 55.23 | + |
| TC20 | 84.63 | 57.39 | 57.31 | 57.64 | 56.34 | 54.03 | + |
| TC21 | 83.79 | 57.94 | 58.40 | 59.50 | 60.44 | 60.18 | + |
| TC22 | 83.66 | 52.85 | 53.59 | 54.81 | 53.20 | 49.61 | + |
| TC23 | 86.54 | 57.06 | 57.75 | 56.69 | 56.93 | 56.49 | + |
| TC24 | 82.86 | 58.13 | 58.00 | 58.28 | 56.98 | 57.35 | + |

[*]
+ similar or better than TC1 with A1 (reference sample)
0 slightly worse than TC1 with A1 (reference sample)
− worse than TC1 with A1 (reference sample)

TABLE 12
Measurement of ΔYI, rating ΔYI and rating gloss 20°
for the short and long time test and overall rating

| | Sample | | | | | | |
|---|---|---|---|---|---|---|---|
| | | ΔYI | Gloss | | ΔYI | Gloss | |
| | | rating | rating | | rating | rating | |
| | ΔYI | [**] | [*] | ΔYI | [***] | [*] | |
| | Test | | | | | | Overall |
| | short | short | short | long | long | long | rating |
| | time | time | time | time | time | time | [****] |
| TC1 | reference | | | | | | |
| TC2 | 1.04 | + | + | −1.43 | ++ | + | ++ |
| TC3 | −0.43 | ++ | ++ | 6.71 | + | + | + |
| TC4 | −1.5 | ++ | + | −4.17 | ++ | + | ++ |
| TC19 | 1.27 | + | + | −6.64 | ++ | + | + |
| TC20 | 5.42 | − | + | −1.33 | ++ | + | + |
| TC21 | 1.15 | + | + | −0.58 | ++ | + | + |
| TC22 | 0.87 | + | + | −2.75 | ++ | + | + |
| TC23 | 1.86 | + | + | −4.19 | ++ | + | + |
| TC24 | 1.03 | + | + | −6.45 | ++ | + | ++ |

[*]
+ similar or better than TC1 with A1 (reference sample)
0 slightly worse than TC1 with A1 (reference sample)
− worse than TC1 with A1 (reference sample)
[**]
++ better than TC1 with A1 (reference sample): ΔYI < 0
+ similar than TC1 with A1 (reference sample): 0 < ΔYI < 2
0 slightly worse than TC1 with A1 (reference sample): 2 < ΔYI < 4
− much worse than TC1 with A1 (reference sample): ΔYI > 4
[***]
++ better than TC1 with A1 (reference sample): ΔYI < 0
+ similar than TC1 with A1 (reference sample): 0 < ΔYI < 7.5
0 slightly worse than TC1 with A1 (reference sample): 7.5 < ΔYI < 15
− much worse than TC1 with A1 (reference sample): ΔYI > 15
[****]
++ much better than TC1 with A1 (reference sample)
+ similar or better than TC1 with A1 (reference sample)
0 slightly worse than TC1 with A1 (reference sample)
− worse than TC1 with A1 (reference sample)

The experimental results (cp. Tables 10 and 12) show that the molding compositions TC21 to TC24 comprising a combination of the phenolic stabilizers A2 and A3 or a combination of A2 and A4 have a better color stability in the short time- and long time tests than the molding composition TC1 comprising the phenolic stabilizer A1.

The experimental data further show (cp. Table 12) that—especially in the long term ΔY-tests—a better color stability is obtained when the thermoplastic molding compositions TC19 to TC24 are produced with a combination of A2 and A3 or A2 and A4 compared to TC2 to TC4 where only one of the phenolic stabilizers A2, A3 or A4 is used.

The best long term ΔY-test results are obtained with the compositions TC22 to TC24 (using a mixture of phenolic stabilizers A2 and A4).

Additional trials have been conducted where the stabilizer dispersion S2 is applied in the graft polymer CB25 according to example II. The following amounts are applied.

TABLE 13
Composition of the ABS graft copolymers CB25

| | |
|---|---|
| ABS graft copolymer CB | CB25 |
| Stabilizer dispersion | S2 |
| Amount of stabilizer | 120.0 |
| dispersion S2 [g] | |
| Amount of graft copolymer | 8000 |
| CB [g solids] | |
| A2 in graft copolymer CB | 0.600 |
| powder [% by weight] | |

The stabilized graft copolymer CB25 and the phenolic stabilizers A3 or A4 are used in the thermoplastic molding compositions TC25 to TC28. The following components were used; the details are given by Table 14.
Thermoplastic copolymer CA: SAN copolymer prepared according to Example IIIa, 64.74% by weight;
Graft copolymer CB: ABS graft copolymer powder CE25, 34.86% by weight;
Phenolic stabilizers A3 or A4: see Table 14;
Thio co-stabilizer B1: dilauryl thiodipropionate, 0.150% by weight;
Silicon oil D: polydimethylsiloxane with a kinematic viscosity of 1,000 mm²/s; 0.100% by weight.

The total amount of all components is 3000 g.

The thermoplastic molding compositions TC25 to TC28 were produced and tested according to the thermoplastic molding compositions TC1 to TC18.

TABLE 14
Composition of the thermoplastic
molding compositions TC25 to TC28

| | | | ratio A2/A3 or A2/A4 |
|---|---|---|---|
| TC | % by weight A3 | % by weight A4 | % by weight |
| TC25 | 0.0225 | | 90.3/9.7 |
| TC26 | 0.0450 | | 82.3/17.7 |
| TC27 | | 0.0225 | 90.3/9.7 |
| TC28 | | 0.0450 | 82.3/17.7 |

TABLE 15
Measurement of ΔYI and rating ΔYI for the
short and long time test and over-all rating

| | | ΔYI rating | | ΔYI rating | Overall rating |
|---|---|---|---|---|---|
| | ΔΥI | [*] | ΔΥI | [**] | [***] |
| | Test | | | | |
| | short | | long | | |
| Sample | time | short time | time | long time | |
| TC1 | Reference | | | | |
| TC25 | −0.13 | ++ | −12.43 | ++ | ++ |
| TC26 | 2.24 | 0 | −13.26 | ++ | + |
| TC27 | 1.73 | + | −2.82 | ++ | + |
| TC28 | −1.25 | ++ | −9.98 | ++ | ++ |

[*]
++ better than TC1 with A1 (reference sample): ΔYI < 0
+ similar than TC1 with A1 (reference sample): 0 < ΔYI < 2
0 slightly worse than TC1 with A1 (reference sample): 2 < ΔYI < 4
− much worse than TC1 with A1 (reference sample): ΔYI > 4
[**]
++ better than TC1 with A1 (reference sample): ΔYI < 0
+ similar than TC1 with A1 (reference sample): 0 < ΔYI < 7.5
0 slightly worse than TC1 with A1 (reference sample): 7.5 < ΔYI < 15
− much worse than TC1 with A1 (reference sample): ΔYI > 15
[***]
++ much better than TC1 with A1 (reference sample)
+ similar or better than TC1 with A1 (reference sample)
0 slightly worse than TC1 with A1 (reference sample)
− worse than TC1 with A1 (reference sample)

The obtained thermoplastic molding compositions TC25 to TC28, in particular TC25 and TC28, show improved color stabilities as shown by their ΔYI values and rating ΔYI for the short and long time test and overall rating, compared to the reference composition TC1.

1-13. (canceled)

14. A process for the preparation of a thermoplastic molding composition comprising:
0 to 94.996% by weight, based on the total thermoplastic molding composition, of a rubber free thermoplastic copolymer CA comprising at least 50% by weight of one or more vinyl aromatic monomer(s) CA11, and mixtures of monomer CA11 with at least one other co-monomer CA12;
5 to 99.996% by weight, based on the total thermoplastic molding composition, of a graft copolymer CB, comprising
5 to 95% by weight, based on the graft copolymer CB, of at least one graft base CB1, which is obtained by emulsion polymerization of
CB11: 50 to 100% by weight, based on the graft base CB1, of at least one conjugated diene B11,
CB12: 0 to 50% by weight, based on the graft base CB1, of at least one further monomer CB12 selected from styrene, α-methyl styrene, acrylonitrile, methacrylonitrile, and methyl methacrylate; and
5 to 95% by weight, based on the graft copolymer CB, of at least one graft shell CB2, which is obtained by emulsion polymerization in the presence of the at least one graft base CB1 of:
CB21: 50 to 95% by weight, based on the graft shell CB2, of a monomer CB21 selected from styrene, α-methyl styrene, and mixtures of styrene and at least one more monomer selected from α-methyl styrene, p-methyl styrene and (meth)acrylic acid C₁-C₈-alkyl esters;
CB22: 5 to 50% by weight, based on the graft shell CB2, of a monomer B22, selected from acrylonitrile and mixtures of acrylonitrile and at least one more monomer selected from methacrylonitrile, maleic anhydride, phthalic anhydride, N-phenyl maleimide, N-cyclohexyl maleimide;
wherein the sum of CB11+CB12 is 100% by weight; the sum of CB21+CB22 is 100% by weight, and the sum of graft base CB1 and graft shell CB2 is 100% by weight;
0.002 to 5% by weight, based on the total thermoplastic molding composition, of two or more phenolic stabilizers A selected from:
A2: octadecyl 3-(3,5-di-tert-butyl-4-hydroxyphenyl)propionate);
A3: benzenepropanoic acid, 3,5-bis(1,1-dimethylethyl)-4-hydroxy-1,1′-(thiodi-2,1-ethanediyl) ester; and
A4: 2,4,6-tris(3′,5′-di-tert-butyl-4′-hydroxybenzyl)mesitylene;
0.002 to 5% by weight, based on the total thermoplastic molding composition, of at least one thio co-stabilizer B;
optionally up to 2% by weight, based on the total thermoplastic molding composition, of at least one silicon oil component D;
0 to 30% by weight, based on the total thermoplastic molding composition, of at least one further component K selected from: additives and/or auxiliaries different from A, B and D, provided that phenolic stabilizers A1—a butylated reaction product of p-cresol and dicyclopentadiene (CAS Number: 68610-51-5)—are excluded, residues of the at least one surfactant C used for production of the stabilizer dispersion S, and/or at least one further polymer selected from polycarbonates PC, polyestercarbonates PEC and polyamides PA;
which process encompasses the following steps:
x) adding a stabilizer dispersion S to the graft copolymer CB after its emulsion polymerization which stabilizer dispersion S is obtained by a process comprising the following steps, the order of step ii) to v) can be changed:
i) providing an aqueous composition;
ii) adding at least one surfactant C to the aqueous composition;
iii) optionally adding at least one thio co-stabilizer B to the aqueous composition, wherein the temperature of the aqueous composition is higher than or equal to the melting point of the at least one thio co-stabilizer B;
iv) adding at least one, often two or more, of the phenolic stabilizers A to the aqueous composition, wherein the temperature of the aqueous composition is higher than or equal to the melting point of the optionally at least one thio co-stabilizer B, at least 40° C.;
v) optionally adding at least one silicon oil component D;
vi) homogenization of the aqueous composition obtained in steps ii) to v) for producing a stabilizer dispersion S;
xi) precipitation of the graft copolymer CB, obtained in step x) (including the stabilizer dispersion S), by adding a precipitation solution comprising at least one salt;
xii) mechanical dewatering, optional washing and/or optional drying of the precipitated graft copolymer CB obtained in step xi);
prexiii) optionally providing a stabilized pre-mixture of a thermoplastic copolymer CA with at least one, often two or more, of the phenolic stabilizers A, the at least one thio co-stabilizer B, and optionally the at least one silicon oil component D;
prexiii′) optionally providing a stabilized pre-mixture of a thermoplastic copolymer CA with at least one, often two or more, of the phenolic stabilizers A, and the at least one thio co-stabilizer B, and optionally the at least one silicon oil component D;
xiii) optionally mixing the graft copolymer CB obtained in step xii) with the copolymer CA, and optionally with further components K, or
xiii′) optionally mixing the graft copolymer CB obtained in step xii) with the stabilized pre-mixture obtained in step prexiii′), and optionally with further components K; and
xiv) mixing the composition obtained in step xii) or xiii) with at least one, often two or more, of the phenolic stabilizers A, the at least one thio co-stabilizer B, and optionally the at least one silicon oil component D.

15. The process for the preparation of a thermoplastic molding composition according to claim 14 comprising:
5 to 80% by weight rubber free thermoplastic copolymer CA;
15 to 60% by weight graft copolymer CB;
0.01 to 3% by weight of two or more phenolic stabilizers A;
0.01 to 3% by weight of at least one thio co-stabilizer B;
0.001 to 1% by weight, based on the total thermoplastic molding composition, of at least one silicon oil component D; and
0 to 10% by weight, based on the total thermoplastic molding composition, of at least one further component K.

16. The process for the preparation of a thermoplastic molding composition according to claim 14, wherein the two or more phenolic stabilizers A are a combination of phenolic stabilizers A2 and A3, or A2 and A4, or A2, A3 and A4, in a weight ratio A2:A3, or A2:A4, or A2:(A3+A4) of 95 to 55:5 to 45.

17. The process for the preparation of a thermoplastic molding composition according to claim 14, wherein the weight ratio A2:A3, or A2:A4, or A2:(A3+A4) is: 90 to 60:10 to 40.

18. The process for the preparation of a thermoplastic molding composition according to claim 14, wherein the at least one thio co-stabilizer B is selected from B1: dilauryl thiodipropionate and B2: distearyl thiodipropionate.

19. The process for the preparation of a thermoplastic molding composition according to claim 14, wherein in step iv) a combination of phenolic stabilizers A2 and A3, or, a combination of phenolic stabilizers A2 and A4, or phenolic stabilizer A2 alone are added to the aqueous composition.

20. The process for the preparation of a thermoplastic molding composition according to claim 14, wherein in step prexiii′) or xiv) a combination of phenolic stabilizers A2 and A3, or a combination of phenolic stabilizers A2 and A4, or phenolic stabilizer A3 or A4 alone are used as phenolic stabilizer A.

21. The process for the preparation of a thermoplastic molding composition according to claim 14 in which optional steps prexiii′) and xiii′) are present.

22. The process for the preparation of a thermoplastic molding composition according to claim 14, wherein the at least one conjugated diene B11 is 1,3-butadiene and the at least one further monomer CB12 is styrene and/or α-methyl styrene.

23. The process for the preparation of a thermoplastic molding composition according to claim 14, wherein monomer CB21 is styrene and/or α-methyl styrene, and monomer CB22 is acrylonitrile.

24. The process for the preparation of a thermoplastic molding composition according to claim 14, wherein the vinyl aromatic monomer CA11 is selected from styrene and α-methyl styrene, and the at least one other co-monomer CA12 is at least one vinyl cyanide monomer.

25. A thermoplastic molding composition obtained by the process according to claim 14.

26. The process for the preparation of a thermoplastic molding composition according to claim 14 comprising:
0 to 94.996% by weight, based on the total thermoplastic molding composition, of a rubber free thermoplastic copolymer CA comprising at least 50% by weight of one or more vinyl aromatic monomer(s) CA11, selected from styrene and α-methyl styrene, and mixtures of monomer CA11 with at least one other co-monomer CA12, selected from at least one vinyl cyanide monomer.

27. The process for the preparation of a thermoplastic molding composition according to claim 14, wherein the aqueous composition provided in step (i) is water.

28. The process for the preparation of a thermoplastic molding composition according to claim 14, wherein the stabilized pre-mixture optionally provided in step prexiii′) is a mixture of the thermoplastic copolymer CA with at least one, often two or more, of the phenolic stabilizers A selected from a combination of phenolic stabilizers A2 and A3, or a combination of phenolic stabilizers A2 and A4, or phenolic stabilizer A3 or A4 alone.

29. The process for the preparation of a thermoplastic molding composition according to claim 15 comprising:
5 to 80% by weight rubber free thermoplastic copolymer CA;
15 to 60% by weight graft copolymer CB;
0.1 to 1% by weight of two or more phenolic stabilizers A;
0.1 to 1% by weight of at least one thio co-stabilizer B;
0.01 to 0.2% by weight, based on the total thermoplastic molding composition, of at least one silicon oil component D; and
0.01 to 1% by weight, based on the total thermoplastic molding composition, of at least one further component K.

30. The process for the preparation of a thermoplastic molding composition according to claim 16, wherein the weight ratio A2:A3, or A2:A4, or A2:(A3+A4) is: 85 to 65:15 to 35.

31. The process for the preparation of a thermoplastic molding composition according to claim 14, wherein the at least one conjugated diene B11 is 1,3-butadiene and the at least one further monomer CB12 is styrene.

32. The process for the preparation of a thermoplastic molding composition according to claim 14, wherein monomer CB21 is styrene, and monomer CB22 is acrylonitrile.

33. The process for the preparation of a thermoplastic molding composition according to claim 14, wherein the vinyl aromatic monomer CA11 is styrene, and the at least one other co-monomer CA12 is acrylonitrile.
